(19) United States
(12) Patent Application Publication
(10) Pub. No.: US 2010/0174866 A1
(43) Pub. Date: Jul. 8, 2010

(54) MEMORY DEVICE, ELECTRONIC DEVICE, AND HOST APPARATUS

(75) Inventors: Akihisa Fujimoto, Yamato-shi (JP); Hiroyuki Sakamoto, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/663,531

(22) PCT Filed: Jun. 19, 2008
(86) PCT No.: PCT/JP2008/061602

§ 371 Date: Dec. 8, 2009

(30) Foreign Application Priority Data
Jun. 21, 2007 (JP) 2007-164189
Mar. 19, 2008 (JP) 2008-072461

(51) Int. Cl. G06F 12/00; G06F 12/02; G06F 13/40; G06F 15/177

(52) U.S. Cl. 711/115; 711/211; 711/170; 713/2; 711/E12.001; 711/E12.008

(57) ABSTRACT

A memory device (11) includes a semiconductor memory (11c) and a controller (11a). The semiconductor memory (11c) includes a first storage area (11c1) and a second storage area (11c2). The controller (11a) controls the semiconductor m (11c). The memory device (11) is capable of having a first state which is accessible to the first storage area (11c1) and a sec state in which data is readable from the second storage area (11c2). The controller (11a) is configured to recognize a first command, a second command, and a third command. The first command transfers the memory device (11) to the first state after the memory device is turned on. The second command transfers the memory device (11) from the first state to the second state. The third command transfers the memory device (11) to the second state without passing through the first state after the memory device is turned on.

### TECHNICAL FIELD

The present invention relates to a memory device, an electronic device, and a host apparatus. For example, the invention relates to a host apparatus into which a memory card is inserted and initialization of an electronic device and a memory device which can be embedded in the host apparatus.

### BACKGROUND ART

Currently, a memory system such as a memory card, in which a nonvolatile semiconductor memory such as a flash memory is utilized, has been used as a recording medium for music data or video data. A NAND type flash memory can be cited as a typical example of the flash memory used in the memory system. The memory system is inserted into the host apparatus, which performs data transfer with the memory system. An SD (registered trademark) card is well known as a kind of memory system.

There are well known various interfaces between the memory system and the host apparatus. An SD interface can be cited as an example of the interface. The SD interface is an interface between the SD card and a host apparatus which supports the SD card.

Plural signal lines (such as a clock line and a command line) are defined in an SD interface bus. A set of the plural signal lines is dealt with as one bus.

Recently, there is an increasing demand for the host apparatus in which the memory or another device is embedded. From the standpoint of control, sometimes the embedded device is preferably connected to the host apparatus using the SD interface. In the SD interface, plural devices can be connected to one bus using an address (relative card address, RCA) to select the devices. However, in order to determine RCA of each device, it is necessary to prepare means for individually controlling the devices. Therefore, a control signal other than the SD interface is required. Additionally, it is also necessary to individually change an initialization procedure for each device.

There is a need to provide plural buses in the host apparatus in order that the embedded device can be connected to the SD card removable from the embedded device while the initialization procedure is standardized by a standard driver. That is, it is necessary that plural sets of signal lines and a signal pin dedicated to each set be provided in the host apparatus, which complicates a configuration and design of the host apparatus.

Additionally, there is increasingly a demand to connect as many embedded devices as possible. In such cases, it is necessary that the number of buses be increased according to the number of embedded devices. However, efficiency is lowered when the number of buses is simply increased.

Recently, there is increasingly produced a host apparatus in which the flash memory is used as a nonvolatile storage device with no hard disk drive. In the host apparatus, it is necessary that a program code (boot code) used to start up the system be read from the flash memory. The boot code is stored in the embedded flash memory device. The boot code is transferred to the system memory through the host controller and executed. Because sometimes the boot code includes not only a boot loader or a test driver but also OS (operating system), it is normally necessary that the boot code be initially read after power-on of the host apparatus.

However, the existing interface (for example, SD interface) can make a transition to a state in which data is readable from the memory only after passing through a predetermined state such as device initialization. Unfortunately a processing time for the system initialization is lengthened when the interface undergoes such procedures. Additionally, in the case where the boot code is stored in a general area, because the data is managed by a file system in the general area, it is necessary that the file system be implemented in the system before the boot is started.

For example, Jpn. Pat. Appln. KOKAI Publication No. 2006-92019 discloses a conventional semiconductor device.

The present invention provides an electronic device, a memory device, and a host apparatus which can connect plural devices to a bus supporting one-to-one connection.

### DISCLOSURE OF INVENTION

A memory device, being capable of having a first state and a second state, according to an aspect of the present invention includes:

a semiconductor memory which has a first storage area and a second storage area, data of the semiconductor memory being writable in, readable from, and erasable from the first storage area of the semiconductor memory in the first state or being at least readable from the second storage area in the second state; and

a controller which controls the semiconductor memory,

the controller being configured to recognize a plurality of first commands, a second command, and a third command, the first commands transferring the memory device to the first state after the memory device is turned on, each first command including one or more commands, the second command transferring the memory device from the first state to the second state, the third command transferring the memory device to the second state without passing through the first state after the memory device is turned on, the third command including one or more commands,

the controller outputting a response indicating that the memory device makes a transition to the second state, when the memory device makes the transition to the second state by receiving the second command in the first state, and

the controller outputting a response indicating that the memory device makes a transition to the second state, when the memory device makes the transition to the second state by receiving the third command after the memory device is turned on.

An electronic device according to an aspect of the present invention includes a register which retains a destination address used to select the electronic device,

the electronic device being configured to recognize a command with first format and a command with second format, the command with the first format being required to be supplied before initialization of the electronic device is completed after the electronic device is turned on, the command of the first format having no destination addresses and including one or more commands,

the command with the second format being required to be supplied before the initialization of the electronic device is completed after the electronic device is turned on, the command with the second format including a destination address section having a destination address and including one or more commands,

the electronic device outputting a response and executing processing instructed by the command with the first format, when the electronic device receives the command with the first format and the command with the first format is executable by the electronic device,

the electronic device outputting a response and executing processing instructed by the command with the second format, when the electronic device receives the command with the second format having a value equal to a value retained by the register in the destination address section,

the electronic device executing processing instructed by the command with the second format without outputting a response, when the electronic device receives the command with the second format having a value indicating a broadcast in the destination address section, and

the electronic device ignoring the command with the second format with no response, when the electronic device receives the command with the second format having a value other than the broadcast and different from a value retained by the register in the destination address section.

A host apparatus according to an aspect of the present invention:

a slot into which a removable card device is inserted;

a first bus which is connected to the slot;

a first host controller which enables communication with the card device through the first bus, and which initializes the card device;

a plurality of the electronic devices described above, the each register of the electronic devices retaining values different from one another;

a second bus to which a plurality of the electronic devices are connected; and

a second host controller which selects one of the electronic devices through the second bus to enable communication, and which initializes the electronic device by issuing the command with the second format to transfer the electronic device to a state in which the initialization is completed.

### BRIEF DESCRIPTION OF DRAWINGS

FIG. 1 shows a schematic configuration of a device according to a first embodiment of the invention and a host apparatus in which the device of the embodiment is embedded;

FIG. 2 shows the detailed configuration of the embedded device;

FIG. 3 shows a state transition of the embedded memory device according to the first embodiment;

FIG. 4 schematically shows a boot read state transition instruction command;

FIG. 5 schematically shows an extended voltage check command;

FIG. 6 is a flowchart showing an operation of the host apparatus according to the first embodiment;

FIGS. 7 and 8 schematically show an example in which the extended voltage check command is further extended;

FIG. 9 is a flowchart showing an operation of a host apparatus according to a second embodiment of the invention;

FIG. 10 schematically shows a device according to a third embodiment of the invention and a configuration of a host apparatus in which the device is embedded;

FIG. 11 is a flowchart showing an operation of the host apparatus according to the third embodiment;

FIG. 12 is a flowchart showing a boot code read operation in the embedded device, performed by the host apparatus according to a fourth embodiment of the invention;

FIG. 13 is a block diagram schematically showing the host apparatus according to the fourth embodiment;

FIG. 14 is a conceptual view showing ACMD8 used by a host apparatus according to a fifth embodiment of the invention;

FIG. 15 shows a state transition of a device according to the fifth embodiment;

FIG. 16 is a flowchart showing an operation of the host apparatus according to the fifth embodiment;

FIG. 17 is a flowchart showing an operation of the device according to the fifth embodiment;

FIG. 18 is a flowchart showing an operation of a host apparatus according to a sixth embodiment of the invention;

FIG. 19 is a flowchart showing an operation of a host apparatus according to a seventh embodiment of the invention;

FIG. 20 is a flowchart showing an operation of a host apparatus according to an eighth embodiment of the invention;

FIG. 21 is a block diagram showing a host apparatus according to a ninth embodiment of the invention;

FIG. 22 is a flowchart showing an operation of the host apparatus according to the ninth embodiment;

FIG. 23 shows a state transition of a device according to the ninth embodiment; and

FIGS. 24 to 26 are flowcharts showing an operation of the host apparatus according to the ninth embodiment.

### BEST MODE FOR CARRYING OUT THE INVENTION

Embodiments of the invention will be described below with reference to the accompanying drawings. In the following description, a component having substantially the same function and configuration is designated by the same reference character, and overlapping description is provided only when it is necessary. However, the drawings are a schematic expression, and obviously the drawings differ from one another in a size relationship and a ratio among components.

In the following embodiments, an apparatus and a method are illustrated only by way of example in order to materialize a technical thought of the present application, and the technical thought does not limit materials, shapes, structures, and arrangements of the components to the following embodiments. For the technical thought, various modifications and changes can be made in the scope of claims of the present application.

In each embodiment of the invention, each functional block can be realized by one of or a combination of hardware and computer software. Therefore, from the viewpoint of function, each block is described below so as to be clearly manifested as the hardware and computer software. Whether the function is performed as the hardware or software depends on the specific embodiment or design restriction imposed on the whole system. Although those skilled in the art can realize the functions by various methods in each specific embodiment, determination of the realization is also included in the scope of the present application.

### First Embodiment

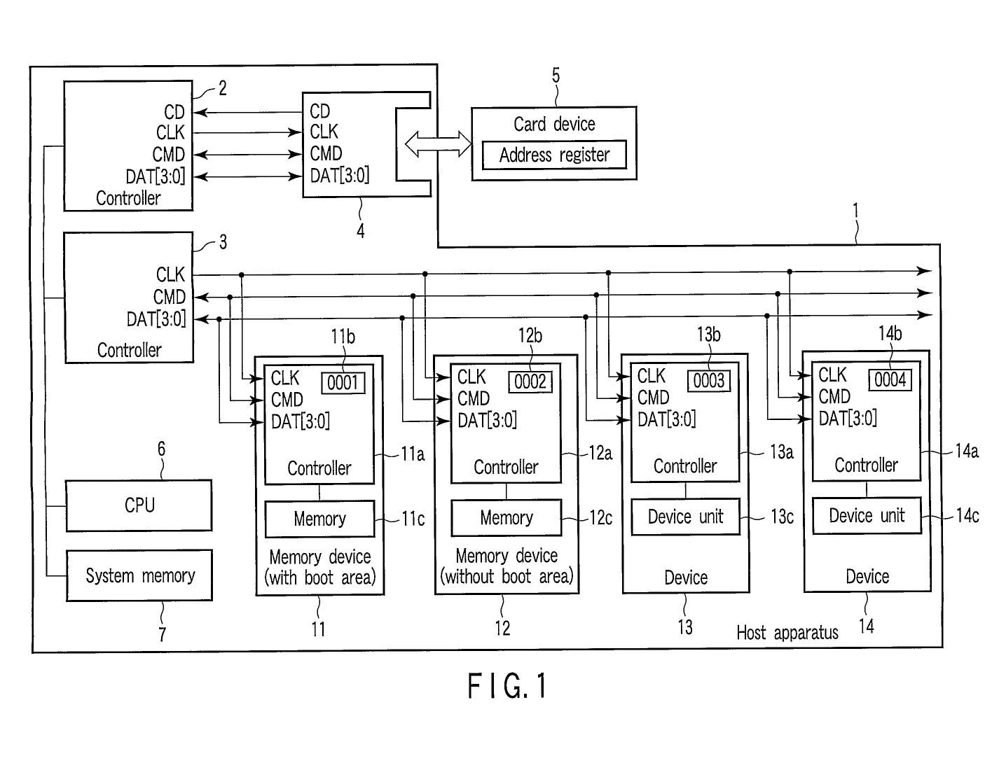

An electronic device and a host apparatus according to a first embodiment of the present invention will be described below. The electronic device of the first embodiment has a configuration in which the electronic device can be embedded in the host apparatus, and the host apparatus supports the electronic device. The electronic device and the host apparatus of the first embodiment will be described with reference to FIGS. 1 to 8.

FIG. 1 shows a schematic configuration of a device according to the first embodiment of the present invention and a host apparatus in which the device of the embodiment is embedded. Referring to FIG. 1, a host apparatus 1 includes two host controllers 2 and 3, a slot 4, a CPU (Central Processing Unit) 6, and a system memory 7.

The CPU 6 controls the entire operation of the host apparatᵤₛ 1, and operates according to a program stored in ROM (Read Only Memory, not shown). The system memory 7 is used in order that the CPU 6 temporarily stores various data in the system memory 7, and the system memory 7 is also used to execute an executable program.

The host controllers 2 and 3 include various pieces of hardware and software and protocols necessary to conduct communication with a device (element) connected through a bus. Specifically, the host controllers 2 and 3 are configured to enable communication through the bus including plural signal lines. Examples of the signal line of the bus include a command line, a data line, a clock line, and a power supply line. In a part of the functions of the host controllers 2 and 3, signals are supplies and fed through the signal lines according to a predetermined rule. More specifically, the host controllers 2 and 3 analyze a signal supplied through the bus, recognize a previously set bit pattern from the signal, and capture a command from the signal. Similarly the host controllers 2 and 3 recognize a predetermined bit pattern to capture data from the signal. There are prepared various commands defined in the host controllers 2 and 3. The host controllers 2 and 3 can be materialized as a part of the functions of CPU executed by control of the software or a semiconductor chip such that the functions can be realized.

More specifically, the host controllers 2 and 3 support the clock line, the command line, and the data line. That is, the host controllers 2 and 3 are configured to perform data transfer through the clock line, command line, and data line.

Further specifically, the host controllers 2 and 3 are configured to control the SD interface. An SD interface module on a signal reception side captures the signals on the command line and data line when the signal on the clock line rises. An SD interface module on a signal transmission side supplies a command (and a response) and data to the command line and data line when the signal on the clock line rises (or falls). The data line includes a four-bit signal, that is, the data can be transferred in parallel using the four signal lines.

The host controller 2 is connected to the slot 4 through the signal lines (for example, the clock line, the command line, the data line, and the power supply line) forming the one bus. The slot 4 is configured such that a removable card device 5 can be removably inserted. Examples of the card device 5 include a memory system and other devices which are supported by the slot 4.

The slot 4 includes a terminal which is connectable to the card device 5, and each line in the interface is connected to the corresponding terminal. In the case where the host controller 2 supports the SD interface, the terminals corresponding to the clock line, command line, and the four-bit data line are provided in the slot 4 as shown in FIG. 1. The card device 5 shall include any card device which is configured to communicate with the host apparatus through the SD interface such as an SD card and an SD IO card.

The slot 4 detects whether or not the card device 5 is inserted, and supplies a card detection signal CD to the host interface 2. The card detection signal CD indicates whether or not the card device 5 is detected.

The bus of the host controller 3 is connected to plural embedded devices (four embedded devices in FIGS. 1) 11 to 14 through the signal lines (for example, the clock line, the command line, the data line, and the power supply line) forming the one bus. Any type of device configured to be capable of communicating with the CPU 6 through the host controller 3 can be used as the embedded devices 11 to 14. For example, a memory device and a wireless LAN (local area net work) device can be used as the embedded device. A main part of the device which can be used as the embedded devices 11 to 14 can be realized by a well-known technique according to functions of the embedded devices 11 to 14. On the other hand, in the embedded devices 11 to 14, an element which controls the interface is configured according to the first embodiment as described later. The embedded devices 11 to 14 can be realized by utilizing the semiconductor chip sealed in the portable device such as the SD card.

The embedded devices 11 to 14 include device units 11b, 12b, 13b, and 14b in order to perform main functions (such as a memory function and a wireless LAN function) of the embedded devices 11 to 14 respectively.

The embedded devices 11 to 14 include controllers (device controller) 11a, 12a, 13a, and 14a respectively. Using the interface, the controllers 11a, 12a, 13a, and 14a are configured to be capable of communicating with the CPU 6 through the host controller 3. That is, the embedded devices 11 to 14 include hardware and software configurations in order to support the interface. The controllers 11a, 12a, 13a, and 14a and the host controller 3 are electrically connected such that the communication can be conducted through the signal lines constituting the bus which connects the controllers 11a, 12a, 13a, and 14a and the host controller 3.

In the case where the host controllers 2 and 3 support the SD interface, the controllers 11a to 14a is configured to also support the SD interface. The controllers 11a, 12a, 13a, and 14a may be realized as CPU or the semiconductor chip which is independent of the device units 11b, 12b, 13b, and 14b. As described above, the controllers 11a, 12a, 13a, and 14a may be realized as the semiconductor chip in which the controllers 11a, 12a, 13a, and 14a and the device units 11b, 12b, 13b, and 14b are unitized.

The controllers 11a, 12a, 13a, and 14a include address registers 11b, 12b, 13b, and 14b which retain destination addresses respectively. A unique address to each of the embedded devices 11 to 14 is written in each of the address registers 11b, 12b, 13b, and 14b. The addresses of the embedded devices 11 to 14 are fixed in shipping the host apparatus 1. In shipping the host apparatus 1, an address value of each of the embedded devices 11 to 14 is inputted to the host apparatus 1 (for example, to ROM (not shown) in the host apparatus 1). Therefore, the host apparatus 1 obtains the address values of the embedded devices 11 to 14.

In the case where the SD interface is used in the first embodiment, a relative card address (RCA) can be used as the address. RCA has a unique value dynamically allocated to each device by negotiations between the host apparatus and the device in which the SD interface is used, when the host apparatus initializes the device in which the SD interface is used. Referring to FIG. 1, addresses 0001, 0002, 0003, and 0004 are allocated to the embedded devices 11, 12, 13, and 14, respectively.

At least one (embedded device 11) of the embedded devices 11 to 14 is a memory device. The embedded device (hereinafter sometimes referred to as embedded memory device) 11 includes a NAND type flash memory 11c. The NAND type flash memory 11c includes plural blocks as a storage area. Each block includes plural memory cells connected in series. Each memory cell includes a so-called stack gate structure MOSFET (metal oxide semiconductor field effect transistor). The stack gate structure MOS transistor includes a tunnel insulating film, a floating gate electrode, an inter-electrode insulating film, a control gate electrode, and a source/drain diffusion layer. In each memory cell transistor, a threshold voltage is changed according to the number of electrons accumulated in the floating gate electrode, and information is recorded according to the difference in threshold voltage. A control circuit including a sense amplifier and a voltage generating circuit of the memory has a configuration in which multi-bit data can be written in and read from the memory cell transistor. The write and read of the data is performed in a page unit. The erase of the data is performed in a block unit including plural pages.

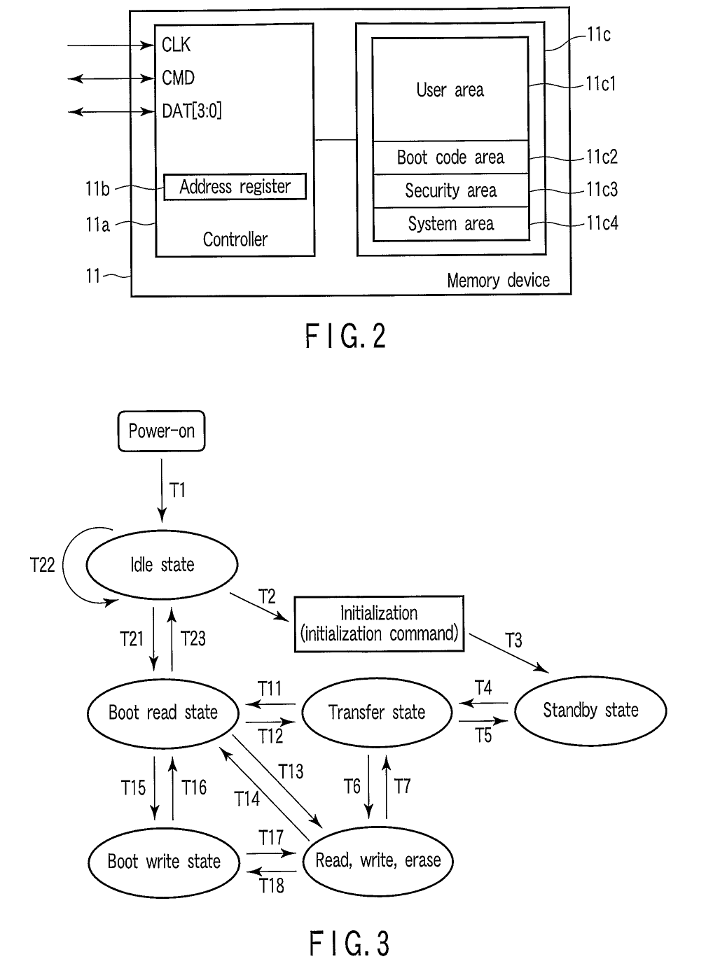

As shown in FIG. 2, the storage area of the flash memory 11c is divided according to application and a kind of stored data. The host apparatus and a user of the host apparatus can freely access and use a user area 11c1. For example, various kinds of data and a program necessary to operate the host apparatus are stored in the user area 11c1.

The data which can be accessed only by the specific host apparatus 1 is stored in a security area 11c3, and the user of the host apparatus 1 can access the security area 11c3 only when satisfying a predetermined condition. The data in the user areas 11c1 and 11c3 is formatted and managed by an arbitrary file system (for example, FAT file system).

The host apparatus 1 and the user cannot directly access a system area 11c4, and the controller 11a manages the system area 11c4. For example, information on control of the controller 11a and security information are stored in the system area 11c4.

The boot code is stored in a boot code area (boot area) 11c2. The boot code is a set of codes for executing at least part of a series of processes, and the series of processes is required to be executed before a system (OS) is started up after the host apparatus 1 is turned on.

The data in the boot area 11c2 is not managed using the file system. The boot codes are stored in the boot area 11c2 in the order from a page of a lower address to a page of a higher address. After the host apparatus 1 is turned on, the host apparatus 1 reads the boot codes in the boot area 11c2 to the system memory 7 in the order from the lower address to the higher address by certain means, and the CPU 6 executes the boot codes to perform the series of processes before the system is booted up. Accordingly, the system includes the file system, so that the file system can be used after the system is started up.

Another memory device (embedded device 12) is included in the embedded devices 11 to 14. A boot area is not provided in the embedded device (hereinafter sometimes referred to as embedded memory device) 12. That is, the embedded memory device includes plural areas in which the boot area of FIG. 2 is eliminated, specifically a general area, the security area, and the system area.

The embedded memory devices 11 and 12 will be described below. FIG. 3 shows a state transition of the embedded memory device according to the first embodiment. Although the following description corresponds to the case in which an interface is used, the first embodiment is not limited to the following description.

As shown in FIG. 3, when the embedded memory devices 11 and 12 are turned on, the host apparatus supplies a reset command (CMD0 in the SD interface) to the embedded memory devices 11 and 12 (transition T1). This enables the embedded memory devices 11 and 12 to make a transition to an idle state (initial state). In the interface used in the description of FIG. 3, it is prescribed that the reset command should be supplied immediately after the power-on. However, the prescription is not always necessary. The reset command can be issued whenever the embedded device is transferred to the idle state.

Then, the embedded memory devices 11 and 12 execute processing necessary to make a transition to a state in which the data can be read from the embedded memory devices 11 and 12, the data can be written in the embedded memory devices 11 and 12, and the data can be erased from the embedded memory devices 11 and 12 (a state in which the initialization is completed). Various processes exist in the processing according to the interface used, and the processing will be described below with reference to a specific example. For example, although being different from the following example, an interface which one command makes a transition to the state in which the initialization is completed is also included in the first embodiment.

First, a voltage check command (CMD8 in the SD interface) is supplied (transition T2). A command provided in a well-known interface can be used as the voltage check command. When receiving the voltage check command, the embedded memory devices 11 and 12 supply responses indicating voltage ranges supported by the embedded memory devices 11 and 12. Sometimes the host apparatus 1 sets the confirmation of the voltage range with the command to an initialization start condition.

A voltage check command can be used, including those described in International Patent Application No. PCT/JP2005/021689 (WO 2006/057340), the entire contents (all pages) of this reference being incorporated herein by reference. The voltage check command includes a command section, a reserve section, a voltage range identification section, a check pattern section, and an error detection code section. The command section has a unique bit pattern indicating the voltage check command. The voltage range identification section has a bit pattern indicating the voltage range supported by the host apparatus 1. The check pattern section is used in order that the host apparatus confirms validity of the voltage check command and a response to the voltage check command using a later-mentioned response. The check pattern section has a predetermined bit pattern. The error detection code section includes an error detection code such as CRC (cyclic redundancy check). When receiving the voltage check command, the embedded memory devices 11 and 12 send back a response. The response has the same format as the command, and a bit pattern clearly indicating the voltage range supported by the memory device is formed in the voltage range identification section of the response.

Then, a memory device initialization command (ACMD41 in the SD interface) is supplied to the embedded memory devices 11 and 12, which in turn start the initialization. When the initialization is completed, an ID (CID) transmission request command and an address transmission request command are supplied to the memory device, the memory device supplies responses for the commands, and the memory device makes a transition to a standby state (transition T3). A command defined in the well-known interface can be used as the ID transmission request command, and the ID transmission request command requests transmission of a unique ID number of the device with which the communication is conducted through the interface (CMD2 in the SD interface). A command defined in the well-known interface can be used as the address transmission request command, and the address transmission request command requests an address proposal to the device with which the communication is conducted through the interface (CMD3 in the SD interface). The address is used in order that the host apparatus identifies the device connected to the host apparatus. The host apparatus approves the proposed address when the address proposed by the device does not overlap the already-allocated address, otherwise the host apparatus requests again a proposal of another address. Alternatively, the host apparatus may specify different addresses to the devices. In such cases, it is not necessary to makes a request again.

A device selection command is supplied to the embedded memory devices 11 and 12, which make the transition to a transfer state (transition T4). The supply of the device selection command transfers the embedded devices 13 and 14 to a command reception state similar to the transfer state. Even if the name of the command reception state in the embedded devices 13 and 14 differs from the transfer state, the command reception state and the transfer state have the same meaning.

A command defined in the well-known interface can be used as the device selection command, and the device selection command is used to select one device when plural devices are connected to one bus (CMD7 in the SD interface). The device selection command includes an address value of the device to be selected in the form of an argument. In the transfer state, the embedded memory devices 11 and 12 make the transition to the standby state when receiving the device selection command specifying the address different from the address of its own (transition T5).

In the transfer state, when receiving a read command, a write command, and an erase command (CMD17, CMD18, CMD24, CMD25, and CMD38 in the SD interface), the embedded memory devices 11 and 12 make the transition to one of a read state, a write state, and an erase state according to the command for the user area (transition T6). When one of the read, the write, and the erase is ended, the embedded memory devices 11 and 12 make the transition to the transfer state (transition T7). In the case where the read command or write command instructs that the plural blocks are sequentially read or written, the embedded memory devices 11 and 12 receive a data transfer stop command (CMD12 in the SD interface) to make the transition to the transfer state.

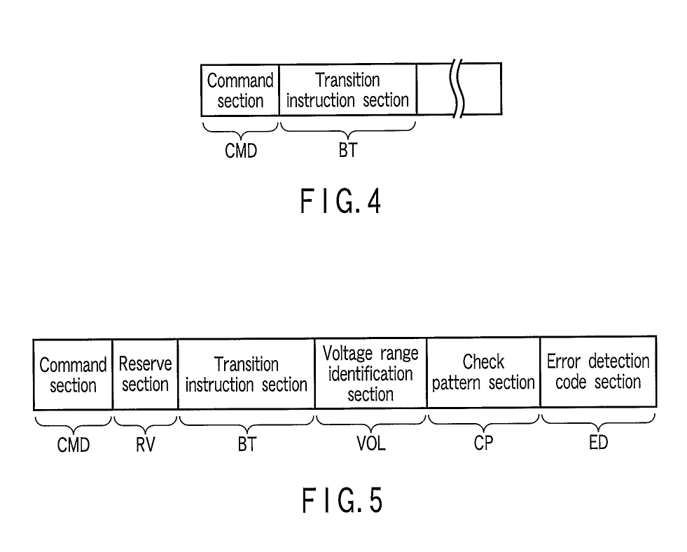

When receiving a command (one of functions of CMD6 in the SD interface) for making a transition to a state (boot read state) in which the boot code area (boot area) can be read in the transfer state, the embedded memory device (embedded memory device 11) having the boot area makes the transition to the boot read state (transition T11). For example, the boot read state transition instruction command has a format shown in FIG. 4. As shown in FIG. 4, the boot read state transition instruction command has at least the command section CMD and a boot read state transition instruction section BT. The command section CMD has a unique bit pattern indicating the boot read state transition instruction command. When the boot read state transition instruction section BT has a bit pattern (for example, “1”) indicating the transition instruction, the memory device having received the boot read state transition instruction command makes the transition to the boot read state. At the same time, the embedded memory device 11 sends back a response to the boot read state transition instruction command. The response has the same format as the boot read state transition instruction command, and a bit pattern (for example, “1”) indicating that the transition to the boot read state is made is formed in the boot read state transition instruction section BT. Alternatively, instead of providing the bit pattern indicating the completion of the transition to the boot read state in the response, the completion of the transition to the boot read state may be indicated in the status supplied on the data line after the response is supplied.

On the other hand, because the embedded memory device 12 does not have the boot area, although the embedded memory device 12 recognizes the boot read state transition instruction command, the embedded memory device 12 ignores the boot read state transition instruction command even if it is supplied. That is, the embedded memory device 12 does not execute contents instructed by the boot read state transition instruction command nor send back the response.

In the boot read state, the embedded memory device 11 makes the transition to the transfer state when receiving the boot read state transition instruction command having the bit pattern (for example, “0”) indicating that the boot read state transition instruction section BT is released (transition T12).

In the boot read state, the embedded memory device 11 reads the data in the boot area when receiving a read instruction command (CMD18 in the SD interface) associated with boot area address specification (transition T13). The host apparatus 1 identifies a boot code size (the number of blocks in which the boot codes are stored) by any well-known method. After the boot code is read, the embedded memory device 11 receives a data transfer stop command (CMD12 in the SD interface) from the host apparatus 1. Therefore, the embedded memory device 11 makes the transition to the boot read state (transition T14).

In the boot read state, the embedded memory device 11 makes a transition to a boot write state when receiving a command for instructing the transition to the boot write state (transition T15). In the boot write state, the embedded memory device 11 makes the transition to the boot read state when receiving a command for instructing the release of the boot write state (transition T16).

In the boot write state, the embedded memory device 11 writes the data in the boot area when receiving a command (CMD25 in the SD interface) for instructing the write associated with boot area address specification (transition T17). After the boot code is written, the embedded memory device 11 receives the data transfer stop command from the host apparatus 1. Therefore, the embedded memory device 11 makes the transition to the boot write state (transition T18). Because the embedded memory device 12 does not have the boot area, although the embedded memory device 12 recognizes the boot write state transition instruction command, the embedded memory device 12 ignores the boot write state transition instruction command nor sends back the response, even if the boot write state transition instruction command is supplied.

In the idle state, the embedded memory device 11 makes the transition to the boot read state when a command for instructing the transition to boot read state is supplied. The transition from the idle state to the boot read state can be realized by utilizing the command which becomes a transition condition from the idle state to the next state. In the state transition of FIG. 3, the voltage check command corresponds to the command which becomes a transition condition from the idle state to the next state.

FIG. 5 shows the voltage check command having the function of instructing the transition to the boot read state. As shown in FIG. 5, the voltage check command includes a command section CMD, a reserve section RV, a boot read state transition instruction section BT, a voltage range identification section VOL, a check pattern section CP, and an error detection code section ED. The command section CMD has the unique bit pattern indicating the voltage check command.

The boot read state transition instruction section BT clearly indicates whether or not the boot read state transition instruction command instructs the boot read state transition. For example, “1” means that the voltage check command requests the transition to the boot read state, and “0” means that the voltage check command requests only the voltage check operation. The command section CMD, the voltage range identification section VOL, the check pattern section CPS, and the error detection code section ED are identical to those of pre-extension voltage check command.

As shown in FIG. 3, the embedded memory device 11 having the boot code area makes the transition to the boot read state when receiving the voltage check command for instructing the transition to the boot read state (transition T21). At the same time, the embedded memory device 11 sends back a response. The response has the same format as the voltage check command. The boot read state transition instruction section (denotation section) BT in the response indicates the completion of the transition to the boot read state, and has the same value as the boot read state transition instruction command.

On the other hand, the embedded memory device 12 which does not have the boot code area remains in the idle state when receiving the voltage check command instructing the transition to the boot read state (transition T22). The embedded device 12 sends back a response whose boot read state transition denotation section indicates that the transition to the boot read state is not made.

In the case where the voltage check command is used to instruct only the voltage check, the boot read state transition instruction section BT has a value (for example, “0”) which does not instruct the transition. In the response, the same value is set to the boot read state transition denotation section BT.

In the boot read state, the embedded memory device 11 makes a transition to the idle state when receiving the reset command (transition T23).

The embedded memory device 11 can directly be transferred to the boot read state without passing through the initialization by utilizing the voltage check command having the boot read state transition instruction section BT. Therefore, the host apparatus 1 can start the boot code read with the minimum number of steps.

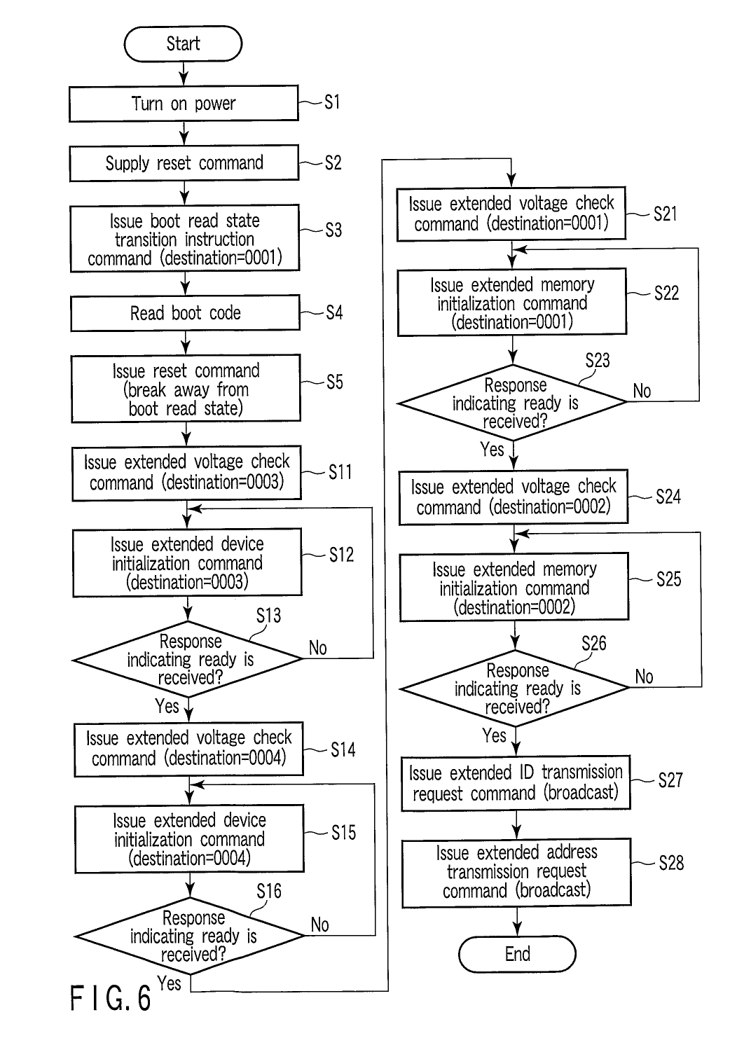

An operation of the host apparatus 1 along with operations of the embedded devices 11 to 14 will be described with reference to FIG. 6. Particularly, the operation from the power-on of the host apparatus 1 (host controllers 2 and 3) to the completion of the initialization of each embedded device will be described. Functions possessed by the host apparatus and embedded devices, which have not been described above, will also be described below.

FIG. 6 is a flowchart showing an operation of the host apparatus according to the first embodiment. FIG. 6 shows processing for transferring the embedded devices 11 to 14 to the state in which the initialization is completed, and the processing is performed prior to the initialization of the card device 5.

Referring to FIG. 6, the host controllers 2 and 3 are turned on (Step S1). Therefore, electric power is supplied to the embedded memory devices 11 to 14. The host controller 3 supplies the reset command to the embedded devices 11 to 14 (Step S2). The reset command is used to transfer the device having received the reset command to the idle state (CMD0 in the SD interface). It is not always necessary to supply the reset command (Step S2). That is, when the host apparatus automatically makes the transition to the idle state in the power-on, it is not necessary for the host controller 3 to supply the reset command. In the case where the embedded devices 11 to 14 are initialized at other than the power-on, the reset command is supplied. The same holds true for the following embodiments.

The host controller 3 makes the transition to the boot read state by utilizing a command which is required to be issued before the start of the initialization. For example, the voltage check command can be utilized as the command.

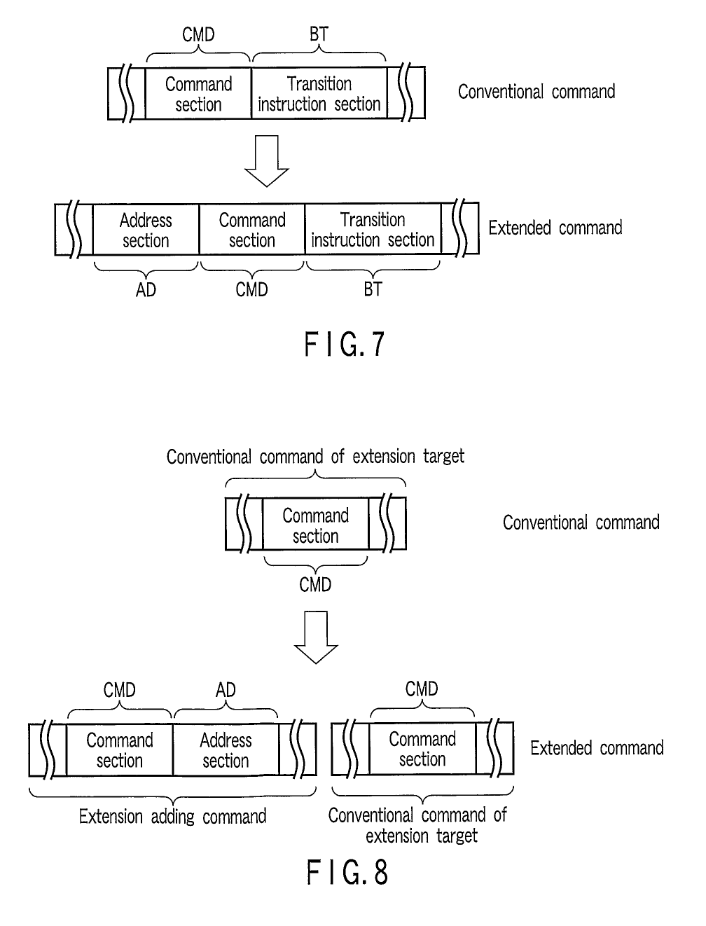

It is not assumed that the voltage check command is used in the state in which plural devices having the boot areas are connected. Therefore, in the first embodiment, the voltage check command is further extended. That is, the voltage check command is extended so as to be valid only for the desired embedded devices 11 to 14. Specifically, as shown in FIG. 7, an address section AD indicating a command destination is inserted in the voltage check command having the boot read state transition instruction section BT. In the SD interface, as shown in FIG. 8, the command extension is supported by adding a command (CMD55) having the address section AD indicating the destination address to a section area immediately in front of the command (hereinafter referred to as conventional command) in the interface assumed to be the one-to-one communication.

The extension of the conventional command will be described below. The extension is performed by inserting the address value in any command (for example, already-described reset command and voltage check command). Only the desired embedded device responds to the extended command by setting the address value of the embedded device to be specified as the destination to the address section AD of the extended command. The embedded device which does not have the destination address ignores the extended command (does not perform contents instructed by the extended command nor send back the response).

On the other hand, a predetermined value (for example, “FFFFh”) is set to the address section AD, which allows the conventional command to be extended for the purpose of broadcast. When the embedded devices 11 to 14 receive the broadcast extended command, the embedded devices 11 to 14 execute processing defined by the command although the embedded devices 11 to 14 do not send back responses. This is because breakages of the responses from the embedded devices 11 to 14 are prevented due to collision of the responses with each other on the bus. Furthermore, compatibility with the conventional device which does not recognize the extended command can be ensured by setting a predetermined value (for example, “0000”) to the address section AD.

Only the embedded device 11 is transferred to the boot read state using the extended voltage check command. Specifically, while the address value (“0001”) of the embedded device 11 of the destination is set to the address section of the extended voltage check command, the boot read state transition instruction section BT is enabled. Although the extended voltage check command having the argument is also supplied to the embedded devices 12 to 14, the embedded devices 12 to 14 are not the command destination. Therefore, the embedded devices 12 to 14 which do not have the destination address ignore the extended command, and remain in the idle state. The embedded devices 12 to 14 in the idle state remain in the idle state unless the embedded devices 12 to 14 receive the command (in the first embodiment, the voltage check command including itself as the destination) to be supplied in the idle state before the embedded devices 12 to 14 are transferred to the state in which the initialization is completed.

When the embedded device 11 receives the extended voltage check command, in which the embedded device 11 is specified as the destination while the transition to the boot readable state is instructed, the embedded device 11 sends back the response indicating that the boot read state transition denotation section is enabled (the transition is made), and makes the transition to the boot read state (Step S3). The response has the same format as the extended voltage check command. Unlike the communication with the card device 5, the host controller 3 previously obtains a working voltage range of the embedded device 11 and the address which should be obtained in processing until the initialization is completed. Therefore, no problem is generated even if the transition to the boot read state is made without performing the conventional voltage check or the initialization.

The boot read state transition instruction may be made using the pre-extension (address specification does not exist) voltage check command having the boot read state transition instruction section. In such cases, although all the embedded devices 11 to 14 receive the pre-extension voltage check command, because the embedded devices 12 to 14 do not have the boot code area, the embedded devices 12 to 14 ignore the command to remain in the idle state. On the other hand, the embedded memory device 11 recognizes the pre-extension voltage check command to make the transition to the boot read state. However, in the case of the control, it is necessary that only one embedded memory device having the boot code area exist. This is for preventing the responses from the plural embedded devices having the boot code areas from colliding with each other on the bus.

The host controller 3 reads the boot code in the boot code area using the data read command (Step S4). At this point, for example, the command for reading the plural blocks can be used as the data read command. For example, in the case where 0 or FFh is set to the data bits in the head block of the boot code area, it is determined that the boot code does not exist. The boot code size (the number of blocks in which the boot area is stored) can be specified by any method defined by the host system. For example, when a position indicating the boot code size is previously determined, a procedure of reading the boot code can be unified. In the case where the SD interface is used, the boot code can be read using the command CMD18 and the command CMD12. Although the data read command is also supplied to the embedded devices 12 to 14 in addition to the embedded device 11, the embedded devices 12 to 14 do not respond to the data read command because the embedded devices 12 to 14 are in the idle state.

After the boot code is read, the host controller 3 issues the reset command to transfer the embedded device 11 to the idle state (Step S5).

Then, the host controller 3 sequentially initializes the embedded devices 11 to 14 through the same procedure as the conventional technique. In the following description, the embedded devices are initialized in the specific order by way of example. However, the order of the initialization is not limited to the following description. For example, the embedded devices 13 and 14 can be formed by a so-called combo device in which the memory device is also embedded. Assuming that the embedded devices 13 and 14 are formed by the combo device, it may be defined that the extended device initialization command is issued prior to the extended memory device initialization command. The following description corresponds to the case in which the extended device initialization command is issued prior to the extended memory device initialization command.

The host controller 3 supplies the extended voltage check command, in which the address (0003) of the embedded device 13 is set to the argument of the address section while the boot read state transition instruction is disabled (Step S11). In the embedded devices 11 to 14, only the embedded device 13 sends back the response to the extended voltage check command. Step S11 is omitted in the case where the embedded device 13 does not support the extended voltage check command. As described above, because matching is established between the supply voltages of the embedded devices 11 to 14 and the working voltage of the host controller 3, no problem is generated even if the voltage check procedure is omitted. However, it is necessary that the embedded device having the boot code area support the extended voltage check command.

Then, the host controller 3 initializes the embedded device 13. At this point, the extended device initialization command can be used. The technique described with reference to FIGS. 7 and 8 can be adopted as the extension method. A command defined in the well-known interface can be used as the device initialization command, and the device initialization command requests the initialization of the device other than the memory device (CMD5 in the SD interface). The host controller 3 supplies an extended SD IO device initialization command in which the address (0003) of the embedded device 13 is set to the argument of the address section (Step S12).

When receiving the extended device initialization command, the embedded device 13 supplies a response indicating busy while starting the initialization. The host controller 3 repeats Step S12 until the initialization is completed to receive a response indicating ready (Step S13). When the initialization is completed, the flow goes to Step S14 to start processing for initializing the embedded device 14.

In Steps S14 to S16, the same processing as those in Steps S11 to S13 is performed to the embedded device 14. Steps S14 to S16 differ from Steps S11 to S13 in that the address section in the extended device initialization command has address value of (0004) of the embedded device 14. When receiving the extended device initialization command, the embedded device 14 starts the initialization. Step S14 is omitted in the case where the embedded device 14 does not support the extended voltage check command. When the initialization of the embedded device 14 is completed, the flow goes to Step S21 to start processing for initializing the embedded device 11.

In Steps S21 to S23, the same processing as those in Steps S11 to S13 is performed to the embedded device 11. Steps S21 to S23 differ from Steps S11 to S13 in that the extended memory device initialization command is used in Step S22. The technique described with reference to FIGS. 7 and 8 can be adopted as the extension method. The address section of the memory device initialization command has address value of (0001) of the embedded device 11. When receiving the memory device initialization command, the embedded device 11 starts the initialization. When the initialization of the embedded device 11 is completed, the flow goes to Step S24 to start processing for initializing the embedded device 12.

In Steps S24 to S26, the same processing as those in Steps S21 to S23 is performed to the embedded device 12. Steps S24 to S26 differ from Steps S21 to S23 in that the address section of the extended memory device initialization command has address value of (0002) of the embedded device 12. When receiving the extended memory device initialization command, the embedded device 12 starts the initialization. When the initialization of the embedded device 12 is completed, the flow goes to Step S27.

In the case of at least five embedded devices, the same processing as those in Steps S11 to S26 is performed to all the embedded devices until the initialization is completed for the embedded devices. Then, the flow goes to Step S27.

The processing necessary to transfer the embedded devices 11 to 14 to the state in which the initialization is completed are performed in Steps S27 and S28. In Step S27, the host controller 3 issues an extended ID transmission request command. The extended ID transmission request command is obtained by extending the ID transmission request command using the technique described with reference to FIGS. 7 and 8. In Step S27, the address section of the extended ID transmission request command has a value meaning the broadcast. Therefore, the embedded devices 11 to 14 do not send back ID even if the embedded devices 11 to 14 receive the extended ID transmission request command.

In Step S28, the host controller 3 issues an extended address transmission request command. The extended address transmission request command is obtained by extending the address transmission request command using the technique described with reference to FIGS. 7 and 8. In Step S28, the address section of the address transmission request command has the value meaning the broadcast. Therefore, the embedded devices 11 to 14 do not send back the proposal address even if the embedded devices 11 to 14 receive the extended address transmission request command.

The embedded devices 11 to 14 make the transition to the standby state subject to the completion of Step S28. Then, in the case where the card device 5 is inserted into the host apparatus 1, the host controller 2 performs processing necessary to initialize the card device 5 according to the conventional method.

In the first embodiment, the embedded devices 11 to 14 are embedded in the host apparatus 1. However, the embedded devices 11 to 14 are not limited to the application in which they are embedded in the host apparatus 1. For example, the embedded devices 11 to 14 of the first embodiment are formed into one chip and sealed by a package, thereby realizing a card device which can be inserted into the host apparatus 1 through the slot 4.

Thus, the embedded memory device 11 of the first embodiment supports the interface which supports the command for instructing the transition to the state in which the predetermined area (boot code area) can be read in the command for making the transition to the next state from the initial state after the power-on of the host apparatus. Therefore, the embedded memory device 11 can access the predetermined area while omitting the processing (initialization processing) necessary for the transition to the state in which the data can be written, read, and erased. Accordingly, the data, for example the boot code, necessary to be read at an early stage is stored in the predetermined area, which allows the data to be accessed immediately after the electric power supply is started to the host apparatus 1.

In the host controllers 2 and 3 and controllers 11a, 12a, 13a, and 14a of the first embodiment, the command which does not have the function of specifying the address defined in the conventional interface assumed to be the one-to-one communication is extended such that the destination address can be specified. Therefore, even if the plural devices are connected to the bus of the conventional interface, the devices can be initialized.

A load capacity of one bus interface depends on the number of embedded devices connected to the bus interface. Therefore, the function of adjusting a driving ability is added to an I/O cell of the host apparatus 1 or embedded devices 11 to 14, or the working frequency is lowered according to a delay generated due to the load capacity, which allows the adjustment to be made according to the number of embedded devices.

### Second Embodiment

In a second embodiment, the initialization time of the first embodiment is shortened.

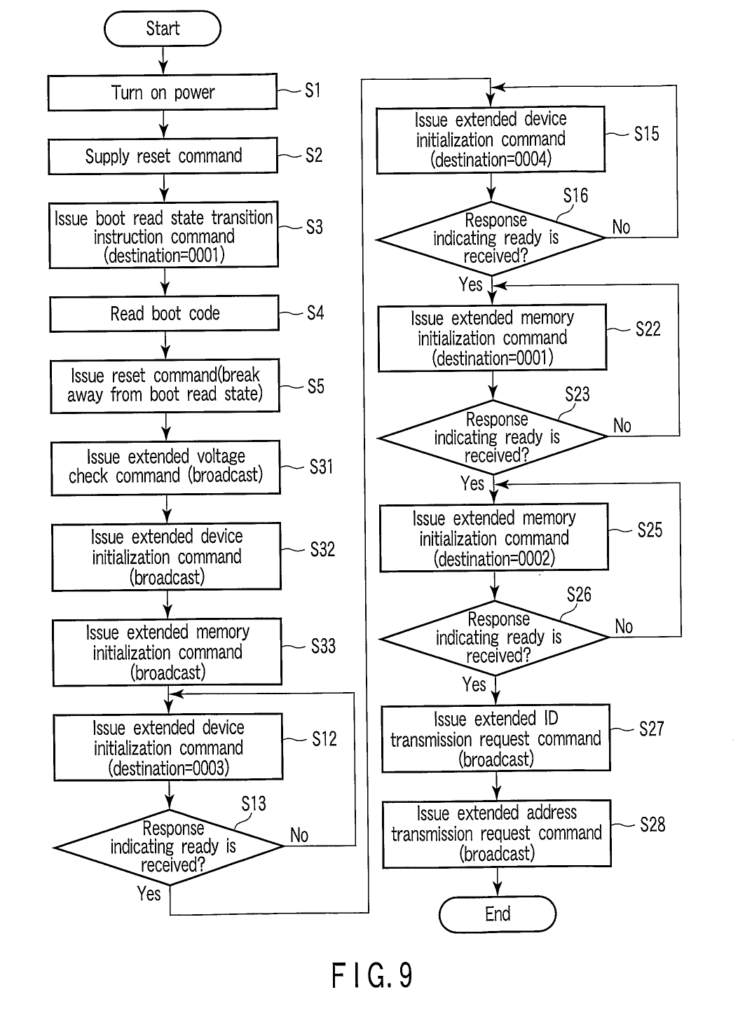

An embedded device of the second embodiment and a host apparatus have the same configurations as in the first embodiment (FIGS. 1 and 2). An operation of the second embodiment will be described with reference to FIG. 9. FIG. 9 is a flowchart showing an operation of a host apparatus of the second embodiment.

Steps S1 to S5 of the second embodiment are identical to those of the first embodiment. Subsequent to Step S5, the host controller 3 supplies the extended voltage check command in which the address section value is set to the broadcast value (Step S31). Even if the embedded devices 11 to 14 receive the extended voltage check command, the embedded devices 11 to 14 do not send back the response. As described above, because the matching is established between the supply voltages of the embedded devices 11 to 14 and the working voltage of the host controller 3, even if the response to the extended voltage check command is not sent back, there is no trouble with the operation of the host apparatus 1. Despite this, the reason why the voltage check command is issued is that sometimes the embedded devices 11 to 14 start the initialization subject to the reception of the voltage check command.

The host controller 3 supplies the extended device initialization command in which the address section value is set to the broadcast value (Step S32). The embedded devices 13 and 14 start the initialization without sending back the response. Therefore, the embedded devices 13 and 14 are concurrently initialized. The embedded memory devices 11 and 12 ignore the extended device initialization command.

The host controller 3 supplies the extended memory device initialization command in which the address section value is set to the broadcast value (Step S33). The embedded memory devices 11 and 12 start the initialization without sending back the response. Therefore, the embedded memory devices 11 and 12 are concurrently initialized. The embedded devices 13 and 14 ignore the extended memory device initialization command. The order of Steps S32 and S33 may be changed. The order is an example determined by assuming that the embedded devices 13 and 14 are the combo devices.

Then, the host controller 3 performs processing for confirming whether or not the initialization is completed for the embedded devices 11 to 14. Specifically, the host controller 3 performs the same processing as Step S12. The host controller 3 repeats the processing in Step S12 until the host controller 3 receives the response indicating ready in which the initialization is completed (Step S13).

Then, the host controller 3 performs the same processing as Step S15. The host controller 3 repeats the processing in Step S15 until the host controller 3 receives the response indicating ready in which the initialization is completed (Step S16).

Then, the host controller 3 performs the same processing as Step S22. The host controller 3 repeats the processing in Step S22 until the host controller 3 receives the response indicating ready in which the initialization is completed (Step S23).

Then, the host controller 3 performs the same processing as Step S25. The host controller 3 repeats the processing in Step S25 until the host controller 3 receives the response indicating ready in which the initialization is completed (Step S26). The order of the confirmation whether or not the initialization is completed for the embedded devices 11 to 14 may be changed.

Then, the embedded devices 11 to 14 make the transition to the standby state by performing the same processing as Steps S27 and S28.

Thus, the embedded devices 11 to 14 and host apparatus 1 of the second embodiment support the same interface as in the first embodiment. Therefore, the same effect as the first embodiment is obtained. The embedded devices 11 to 14 and host controllers 2 and 3 of the second embodiment support the interface which supports the extended command such that the destination address can be specified. Therefore, the same effect as the first embodiment is obtained.

The host controller 3 of the second embodiment transmits the command for instructing the initialization of the embedded devices 11 to 14 in the broadcast manner. Therefore, the embedded devices 11 to 14 are concurrently initialized, so that the time necessary for the initialization can be shortened.

### Third Embodiment

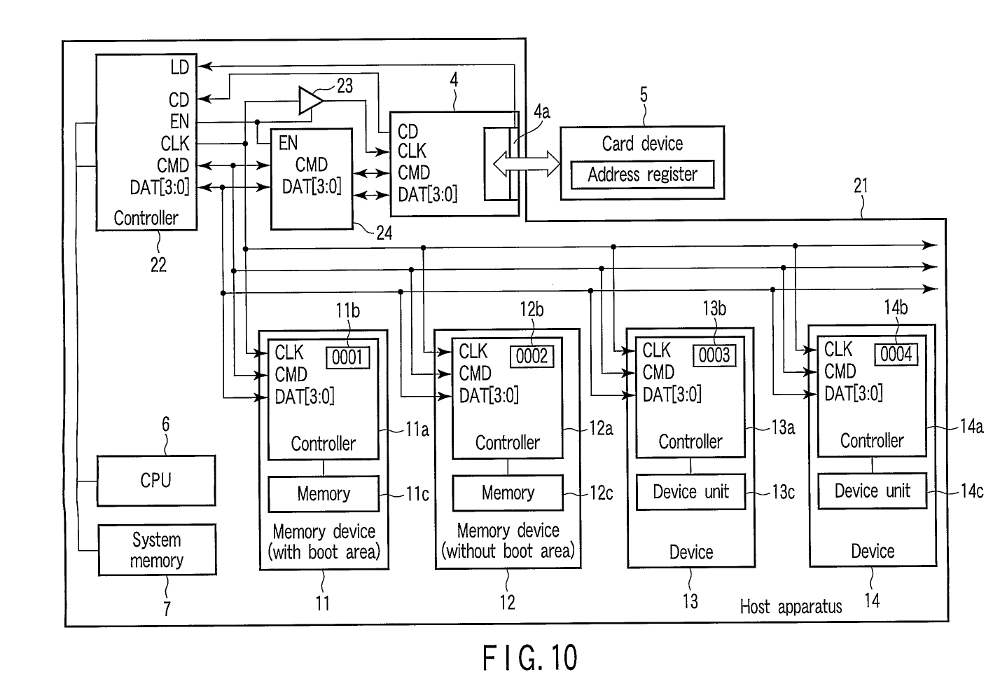

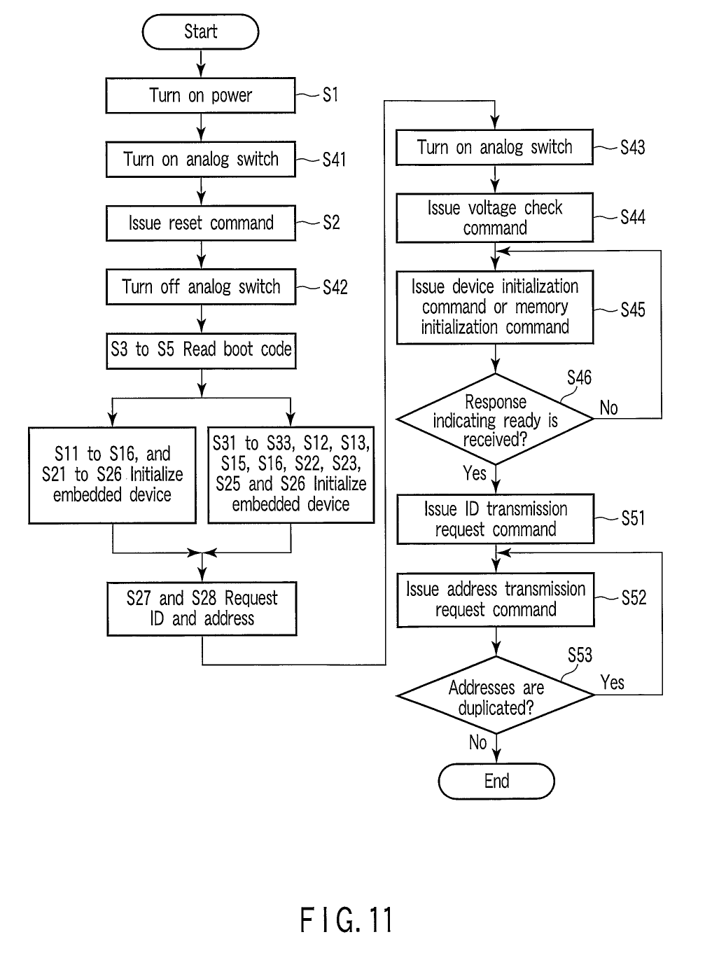

A third embodiment relates to a method of supporting the plural devices with the host apparatus having only one bus. The method according to the third embodiment will be described with reference to FIGS. 10 and 11. FIG. 10 schematically shows a device according to the third embodiment of the invention and a configuration of a host apparatus in which the device is embedded.

As shown in FIG. 10, a host apparatus 21 includes one host controller 22. The host controller 22 has the same configuration as the host controllers 2 and 3 of the first embodiment.

The embedded devices 11 to 14 are connected to the host controller 22 through one bus. The host controller 22 is connected to the slot 4 through a buffer 23 and an analog switch 24. Specifically, the line for the signal flowing only from the host controller 22 toward the slot 4 is connected to the slot 4 from the host controller 22 through the buffer 23. A unidirectional signal line such as the clock line corresponds to the signal line.

For the line for the signal flowing in the both directions between the host controller 22 and the slot 4, the host controller 22 and the slot 4 are connected through the analog switch 24. A bi-directional signal line, such as the command line and the data line, corresponds to the signal line. Although a bi-directional buffer can be used, it is necessary that the host controller 22 control the bus direction using a control signal. Usually the control signal is not prepared. The analog switch 24 may control all the signal lines without utilizing the buffer 23.

When the CPU 6 supplies an enable signal EN to the buffer 23 and analog switch 24 through the host controller 22, the buffer 23 and the analog switch 24 electrically connect the host controller 22 and the slot 4. This enables the CPU 6 to conduct communication with the slot 4 (the card device 5 inserted into the slot 4).

The host controller 22 is also connected to the controllers 11a, 12a, 13a, and 14a through the corresponding signal line (the clock line, the command line, the data line, and the power supply line) respectively.

The slot 4 detects whether or not the card device 5 is inserted, and the slot 4 supplies the card detection signal CD to the host interface 2. The card detection signal CD indicates whether or not the card device 5 is detected. In the case where the card device 5 is not inserted, the CPU 6 keeps the buffer 23 and analog switch 24 turned off. When the slot 4 detects that the card device 5 is inserted, the CPU 6 turns on the buffer 23 and analog switch 24 on the condition that the communication or data transfer is not performed between the embedded devices 11 to 14 and the host controller 22.

The host apparatus 21 has a cover 4a provided in the slot 4. A sensor is provided in the cover 4a. When the cover 4a is opened, the sensor supplies a cover opening and closing signal LD to the host controller 22. This means there is a possibility of removing the card device 5 when the cover 4a is opened. When detecting the possibility of removing the card device 5 from the slot 4 by the cover opening and closing signal LD, the CPU 6 rapidly stops the access to the card device 5 to turn off the buffer 23 and analog switch 24. Therefore, the signal from the slot 4 is prevented from colliding with the signals from the embedded devices 11 to 14 on the bus.

Other configurations are similar to those of the first embodiment.

An operation of the host apparatus of the third embodiment will be described below with reference to FIG. 11. FIG. 11 is a flowchart showing an operation of the host apparatus of the third embodiment. As shown in FIG. 11, the host controller 22 is turned on (Step S1). The host controller 22 enables the enable signal to turn on the buffer 23 and analog switch 24 (Step S41). The host controller 22 issues the reset command (Step S2). The host controller 22 disables the enable signal to turn off the buffer 23 and analog switch 24 (Step S42). Accordingly, the host controller 22 communicates with not the card device 5 but only the embedded devices 11 to 14.

At this point, the embedded devices 11 to 14 are initialized. Specifically, the same processing as those in Steps S3 to S5 of the first embodiment is performed. Then, the same processing as those in Steps S11 to S16, and S21 to S26 of the first embodiment or as those in Steps S31 to S33, Steps S12, S13, S15, S16, S22, S23, S25, and S26 of the second embodiment is performed. Then, the same pieces of processing as those in Steps S27 and S28 of the first embodiment are performed. Accordingly, the embedded devices 11 to 14 make the transition to the standby state. After this, the embedded devices 11 to 14 do not accept the commands except for the command (for example, device selection command) for requesting the state transition from the standby state. Therefore, the host controller 22 is substantially in the state in which the host controller 22 communicates only with the card device 5 inserted into the slot 4.

The host controller 22 turns on the buffer 23 and the analog switch 24 (Step S43). At this point, the host controller 22 initializes the card device 5 to transfer the card device 5 to the standby state.

Specifically, the host controller 22 supplies the voltage check command having the boot read state transition instruction section to the card device 5 (Step S44). The boot read state transition instruction section is invalidated.

The host controller 22 supplies the device initialization command or the memory device initialization command to the card device 5 (Step S45). Once the initialization is started, the card device 5 supplies a response indicating busy. The host controller 22 repeats the processing in Step S45 until the host controller 22 receives the response indicating ready in which the initialization is completed (Step S46).

When the initialization is completed, the host controller 22 further performs processing necessary to transfer the card device 5 to the standby state. Specifically, the host controller 22 reads ID from the card device 5 using the ID transmission request command (Step S51). The host controller 22 receives the address proposal from the card device 5 using the address transmission request command (Step S52). At this point, the embedded devices 11 to 14 also receive the address transmission request command. However, as described above, because the embedded devices 11 to 14 ignore the address transmission request command in the standby state, the address values of the embedded devices 11 to 14 are not changed.

The host controller 22 determines whether or not the address value proposed by the card device 5 is matched with the address values of the embedded devices 11 to 14 (Step S53). When the address value proposed by the card device 5 is matched with the address values of the embedded devices 11 to 14, the flow returns to Step S52, and the host controller 22 requests the proposal of other addresses. The host controller 22 repeats the processing in Step S52 until the address value proposed by the card device 5 is not matched with the address values of the embedded devices 11 to 14. Although the embedded devices 11 to 14 ignore the address transmission request command in the standby state, the card device 5 can accept the address transmission request command to change the address.

As described above, the devices and host apparatus of the third embodiment support the same interface as in the first embodiment. Therefore, the same effect as the first embodiment is obtained. The devices and host apparatus of the third embodiment also support the interface which supports the extended command such that the destination address can be specified. Therefore, the same effect as the first embodiment is obtained. When the method of the second embodiment is adopted to initialize the embedded devices 11 to 14 of the third embodiment, the same effect as the second embodiment is obtained in the host apparatus of the third embodiment.

In the host apparatus 21 of the third embodiment, the host controller 22 and the slot 4 are connected through the buffer 23 and the analog switch 24. Therefore, the slot 4 can electrically be separated from the host controller 22. After the embedded devices 11 to 14 are transferred to the standby state while the slot 4 is separated from the host controller 22, the slot 4 is connected to the host controller 22 to enable the card device 5 to make the transition to the standby state. Therefore, even if the internal devices 11 to 14 and the slot 4 are connected to the one bus, the internal devices 11 to 14 and the slot 4 can properly be initialized.

### Fourth Embodiment

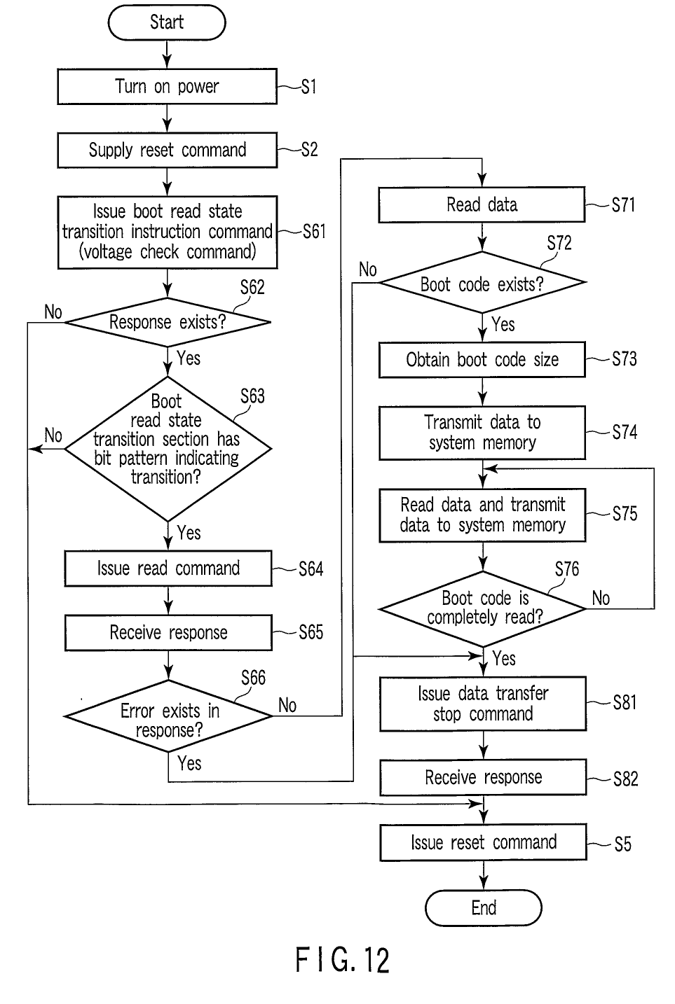

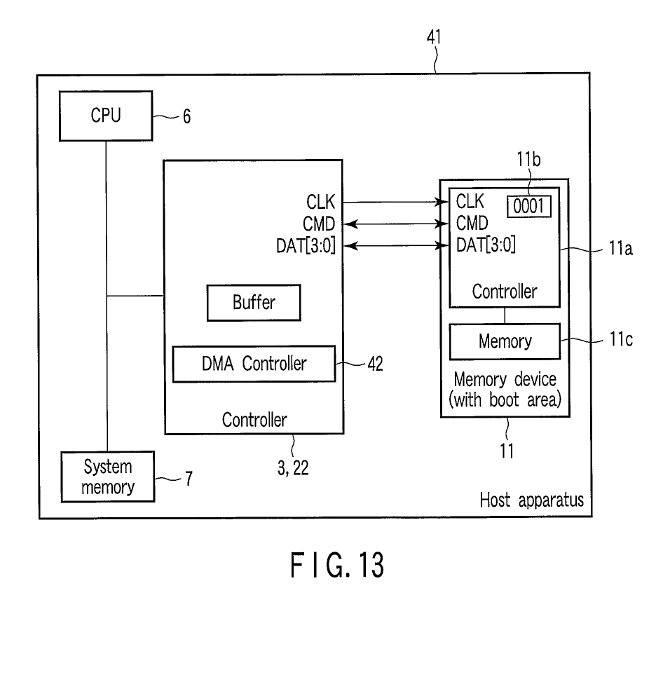

A fourth embodiment relates to the detailed read of the boot code. Therefore, the fourth embodiment can be combined with the first to third embodiments. The fourth embodiment will be described below with reference to FIGS. 12 and 13.

FIG. 12 is a flowchart showing a boot code read operation in the embedded device, performed by the host apparatus of the fourth embodiment. That is, FIG. 12 is a flowchart showing a detailed flow to the completion of the boot code read in the first to third embodiments.

As shown in FIG. 12, the same process as Steps S1 and S2 are performed. Then, the host controllers 3 or 22 supply the command for instructing the transition to the boot read state (Step S61). Similarly to the first embodiment, the voltage check command including the boot read state transition instruction section can be utilized as the command for instructing the transition to the boot read state.

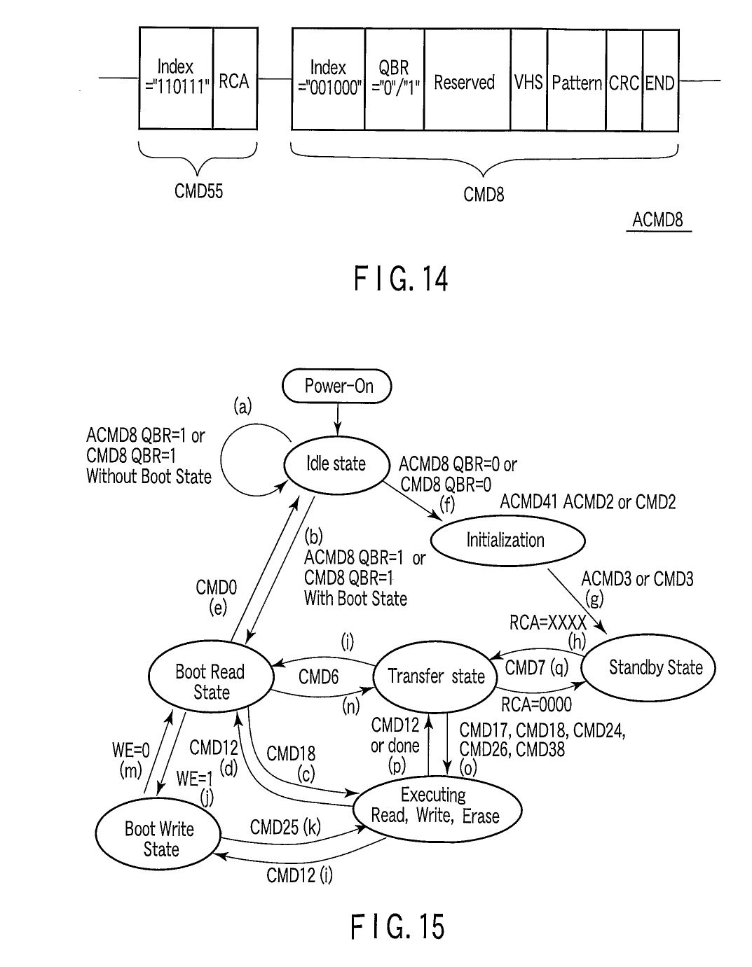

The embedded devices 11 to 14 receive the voltage check command instructing the transition to the boot read state. In the case where any embedded device has the boot area, the embedded device having the boot area (for example, the embedded device 11 of FIG. 3) sends back the response. The boot read state transition instruction section in the response has the bit pattern indicating that the transition is made. Other embedded devices (for example, the embedded devices 12 to 14 of FIG. 14) do not send back the response, because other embedded devices have no boot area.

The extended voltage check command may be used instead of the voltage check command. In such cases, the address (for example, “0001” in FIG. 3) of the embedded device having the boot area is described in the address section of the extended voltage check command.

Then, the host controller 3 or 22 confirms whether or not the response to the voltage check command is sent back (Step S62). When the response is not sent back, because the embedded device having the boot area does not exist, the flow goes to Step S5, and the processing for reading the boot code from the embedded devices 11 to 14 is ended.

When receiving the response to the voltage check command, the host controller 3 or 22 confirms whether or not the boot read state transition section has the bit pattern indicating the transition to the boot read state (Step S63). When the boot read state transition section does not have the bit pattern indicating the transition, the flow goes to Step S5. On the other hand, when the boot read state transition section has the bit pattern indicating the transition to the boot read state, the flow goes to Step S64 such that the host apparatus reads the boot code.

In Step S64, the host controller 3 or 22 issues the read command (Step S64). In the case of the SD interface, the multi-block read command (CMD18) can be used as the read command. The host controller 3 or 22 receives the response to the read command (Step S65). The host controller 3 or 22 confirms whether or not an error exists in the response by confirming the error correction code or the matching of the error detection bit pattern in the response (Step S66).

When the error exists in the response, the flow goes to Step S81. In Step S81, the host controller 3 or 22 issues the data transfer end command (CMD12 in the SD interface) in order to stop the read. Then, the host controller 3 or 22 receives the response to the data transfer end command (Step S82), and the flow goes to Step S5.

On the other hand, when the error is not detected, the host controller 3 or 22 reads the data in the first block of the boot code area and holds the read data into the buffer (Step S71). The data is read from the embedded device 11. The host controller 3 or 22 analyzes the data in the first block to confirm whether or not the boot code exists (Step S72). The determination can be made by previously obtaining a pattern indicating that the boot code does not exist, for example, all the specific sites are set to 0 or 1.

When the boot code does not exist, the host controller 3 or 22 discards contents of the buffer, and the flow goes to Step S81. When the boot code exists, the host controller 3 or 22 analyzes contents of the boot code to obtain boot code size (for example, in how many blocks the boot code is stored) (Step S73). The common procedure can be used by previously obtaining the position of the data indicating the boot code size.

The host controller 3 or 22 transmits the data in the buffer to the system memory 7 (Step S74). The host controller 3 or 22 reads the data of the second block of the boot area and holds the read data into the buffer, and transfer the read data to the system memory 7 (Step S75). Referring to the boot code size obtained in Step S73, the host controller 3 or 22 repeats the processing in Step S75 until all the boot codes are read (Step S76). When the read is completed for all the boot codes, the flow goes to Step S81.

As described in the first embodiment, the command, which enables the transition to the boot read state without passing through the usual initialization processing after the host apparatuses 1 and 21 are turned on, is provided in each embodiment of the invention. Therefore, the number of pieces of necessary processing from the power-on to the boot code read is significantly decreased. Accordingly, for the boot code read processing of the fourth embodiment, instead of the CPU 6, the boot code can automatically be read using a DMA (direct memory access) controller provided in the host controller 3 or 22.

FIG. 13 is a block diagram schematically showing the host apparatus of the fourth embodiment. As shown in FIG. 13, the host controller 3 or 22 includes a DMA controller 42 in addition to the components of the first embodiment. The DMA controller 42 is configured to perform the operation of the fourth embodiment using the well-known technique. When the DMA controller is used, the pieces of processing to the completion of the boot code read can be performed without the CPU 6. In the host apparatus 41, although omitted in FIG. 13, other configurations than the configuration of FIG. 13 are identical to those of the first embodiment (FIG. 1) and third embodiment (FIG. 10).

Thus, the embedded devices 11 to 14 and host controller 3 or 22 of the fourth embodiment support the same interface as in the first embodiment. Therefore, the number of pieces of necessary processing from the power-on of the host apparatus 41 to the transition to the boot code read state is decreased, and therefore the number of pieces of necessary processing from the power-on to the completion of the boot code read is also decreased. Accordingly, the series of pieces of processing can be performed by the DMA controller 42. The effects obtained by the first to third embodiments can also be obtained by combining the fourth embodiment with the first to third embodiments.

### Fifth Embodiment

A fifth embodiment of the invention will be described below. In the fifth embodiment, the first embodiment is described more specifically, and the configuration and operation are basically similar to those of the first embodiment. In the fifth embodiment, a numerical value to which “b” is added expresses a binary number, a numerical value to which “h” is added expresses a hexadecimal number, and a numerical value to which nothing is added expresses a decimal number.

(Extended Voltage Check Command)

The extended voltage check command used in Step S3 of FIG. 6 described in the first embodiment will be described with reference to FIG. 14. FIG. 14 is a diagram schematically showing a configuration of the extended voltage check command. The extended voltage check command can be defined as ACMD8 in the SD interface.

ACMD8 is formed by combining CMD55 and CMD8. CMD55 includes a command index and RCA in the order from the upper bit. A unique number of the command is stored in the command index. For example, “110111b” is stored for CMD55. RCA includes RCA of the device which becomes the destination of the subsequent command (CMD8 in the case of ACMD8).

CMD8 includes the Command index, QBR (Quick Boot Request), Reserved, VHS, Pattern, CRC, and END in the order from the upper bit. The Command index, QBR, Reserved, VHS, Pattern, and CRC correspond to the command section, the boot read state transition instruction section BT, the reserve section RV, the voltage range identification section VOL, the check pattern section CP, and the error detection code section ED, respectively. For CMD8, the Command index is “001000b”. In the case of QBR=¢1b”, CMD8 requests the transition to the boot read state. In the case of QBR=“0b”, CMD8 requests only the voltage check operation. In the following description, it is assumed that QBR is set to “1b”. Hereinafter the operation for requesting the transition to the boot read state is referred to as quick boot.

<State Transitions of Embedded Devices 11 to 14>

The state transitions of the memory devices 11 and 12 and devices 13 and 14 will be described with reference to FIG. 15. FIG. 15 shows the state transition of the memory device 11. The state transitions of the devices 12 to 14 are similar to that of the memory device 11 except that the devices 12 to 14 do not have the boot read state and the boot write state.

The state transitions of FIG. 15 correspond to that of FIG. 3 in the first embodiment. In FIG. 15, the idle state, the initialization, the standby state, the transfer state, (executing read, write, erase) state, the boot read state, and the boot write state correspond to the idle state, the initialization, the standby state, the transfer state, (read, write, erase) state, the boot read state, and the boot write state of FIG. 3, respectively. A name of the specific command used for the transition between the states in the SD interface is described in FIG. 15. Only the main state transitions of the memory device 11 (devices including the boot area) will be described with reference to FIG. 15.

The controller 3 issues the quick boot command to the memory device 11, whereby the memory device 11 directly makes the transition from the idle state to the boot read state without passing through the initialization and standby state. At this point, the controller 3 issues the command of ACMD8 or CMD8 to the memory device 11, and QBR is set to “1b” in the command. CMD8 can be used when only one device supports CMD8 in the host apparatus 1. However, when the plural devices support CMD8, ACMD8 is used because it is necessary that the controller 3 selects the devices to issue the command.

The memory device 11 is initialized when the controller 3 issues ACMD8 or CMD8 in which “QBR is set to “0b”. Then, the controller 3 issues ACMD41, issues ACMD2 or CMD2, and issues ACMD3 or CMD3, thereby transferring the memory device 11 to the standby state. CMD2 and CMD3 are similar to those of the first embodiment, and ACMD2 and ACMD3 are commands in which CMD55 is added to CMD2 and CMD3, respectively.

The controller 3 issues CMD7, whereby the memory device 11 in the standby state makes the transition to the transfer state. Obviously it is necessary that RCA retained by the memory device 11 be included in the argument of CMD7.

The controller 3 issues CMD6, whereby the memory device 11 in the transfer state makes the transition to the boot read state. Contents of CMD6 are similar to those of FIG. 4 in the first embodiment. The controller 3 issues CMD6 in which BT is set to “0b”, whereby the memory device 11 transferred to the boot read state by CMD6 makes the transition to the transfer state. However, in the case where the memory device 11 directly makes the transition from the idle state to the boot read state, even if the controller 3 issues CMD6, the memory device 11 does not make the transition to the transfer state. That is, the transition between the boot read state and transfer state can be made after the initialization is completed.

<Initialization Operation in Controller 3>

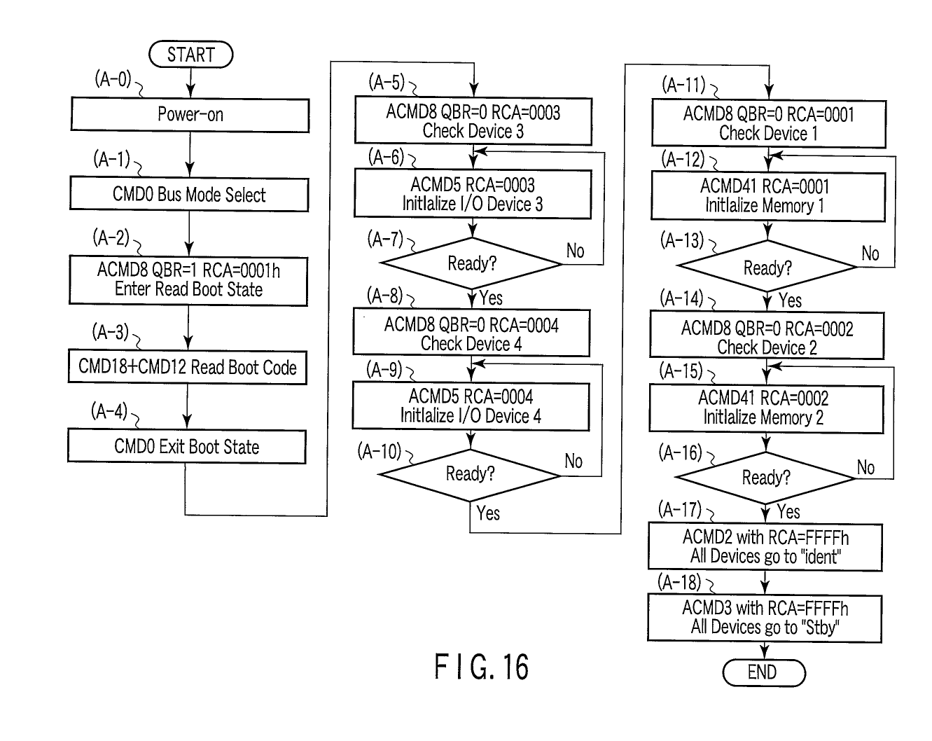

Initialization operations of the embedded devices 11 to 14, performed by the controller 3, will be described below with reference to FIG. 16. FIG. 16 is a flowchart showing a processing flow performed by the controller 3.

As shown in FIG. 16, the controller 3 turns on the embedded devices 11 to 14 (Step A-0). Then, the controller 3 performs processing in Steps A-1 to A-18. The processing in Steps A-1 to A-18 correspond to the processing in Steps S2 to S5, S11 to S16, and S21 to S28 of FIG. 6 in the first embodiment.

The controller 3 issues CMD0 (Step A-1). As described above, CMD0 is the reset command. Therefore, the controller 3 transfers the embedded devices 11 to 14 to the idle state, and sets the bus (CMD line) connecting the controller 3 and the embedded devices 11 to 14 at an input mode. The bus becomes a state for waiting various commands in the SD interface by setting the bus at the input mode.

The controller 3 then issues ACMD8 (Step A-2). In ACMD8, QBR is set to “1b” and RCA is set to “0001h”. That is, the controller 3 provides the quick boot command, and the memory device 11 corresponding to RCA=“0001h” makes the transition to the boot read state. The embedded devices 12 to 14 remain in the idle state.

The controller 3 accesses the boot code area in the memory device 11 using CMD18 and CMD12 (Step A-3). This enables the controller 3 to read the boot code retained in the boot code area.

When the boot code read is ended, the controller 3 issues CMD0 again to transfer the memory device 11 to the idle state (Step A-4). The processing in Step A-4 can be eliminated in the case where the memory device 11 can make the transition to the idle state when the boot code read is ended. The same holds true for FIG. 6.

The controller 3 sequentially initializes the embedded devices 11 to 14. In order to initialize the embedded device 13, the controller 3 issues ACMD8 (QER=“0b” and RCA=“0003h”) (Step A-5). The controller 3 issues ACMD5 (RCA=“0003h”) (Step A-6). ACMD5 is the command including CMD55 and CMD5, and CMD5 is used to perform the initialization of the device other than the memory device. Thus, the embedded device 13 is initialized.

When the embedded device 13 becomes the ready state by the initialization (YES in Step A-7), that is, when the controller 3 receives the response indicating the ready state from the embedded device 13, the controller 3 initializes the embedded device 14. The initialization processing of the embedded device 14 is similar to that of the embedded device 13 (Steps A-8 to A-10).

Then, the controller 3 initializes the memory device 11. The controller 3 issues ACMD8 (QBR=“0b” and RCA=“0001h”) (Step A-11). The controller 3 already issues ACMD8 to the memory device 11 in Step A-2. That is, the voltage checks of the embedded device 11 are already performed once. Accordingly, the processing in Step A-11 may be omitted. The controller 3 issues ACMD41 (RCA=“0001h”) (Step A-12). ACMD41 is the command including CMD55 and CMD41, and CMD41 is used to perform the initialization of the memory device. Thus, the memory device 11 is initialized.

When the memory device 11 becomes the ready state by the initialization (YES in Step A-13), that is, when the controller 3 receives the response indicating the ready state from the memory device 11, the controller 3 initializes the memory device 12. The initialization processing of the memory device 12 is similar to that of the memory device 11 (Steps A-14 to A-16).

Then, the controller 3 issues ACMD2 (RCA=“FFFFh”) (Step A-17), and subsequently issues ACMD3 (RCA=“FFFFh”) (Step A-18). ACMD2 includes CMD55 and CMD2, and CMD2 is used to request the ID transmission to the embedded devices 11 to 14. ACMD3 includes CMD55 and CMD3, and CMD3 is used to request the address transmission to the embedded devices 11 to 14. ACMD2 and ACMD3 are transmitted with RCA=“FFFFh”, that is, the broadcast. Thus, the embedded devices 11 to 14 make the transition to the standby state.

<Initialization Operations in Embedded Devices 11 to 14>

The processing of the embedded devices 11 to 14 in the initialization processing of FIG. 16 will be described below. Flags included in the embedded devices 11 to 14 will be described.

Each of the embedded devices 11 to 14 has two flags, that is, a flag “First CMD55” and a flag “Compatible mode”. The flag “First CMD55” indicates whether or not CMD55 has already been received from the controller 3. The flag “First CMD55” is set to “1b” until the CMD55 is received, and the flag “First CMD55” is set to “0b” when CMD55 is received.

The flag “Compatible mode” is used to change the operation modes of the embedded devices 11 to 14, and the flag “Compatible mode” is set to “1b” immediately after the power-on. In a period during which the flag “Compatible mode” is set to “1b”, the embedded devices 11 to 14 perform the initialization by the procedure in which the conventional SD command is used. That is, ACMD8, ACMD2, ACMD3, and ACMD5 of the embodiments are not used. Hereinafter, the operation mode is referred to as compatible mode.

When a 16-bit RCA number (hereinafter referred to as CRCA) included in the argument of initially-received CMD55 is not “0000h”, the flag “Compatible mode” is set from “1b” to “0b”. That is, when the initially-received CMD55 is the command for selecting one of the embedded devices 11 to 14, the flag “Compatible mode” is set to “0b”. When the flag “Compatible mode” is set to “0b”, the embedded devices 11 to 14 perform the initialization by the procedure in which the extended SD command of the embodiment is used. That is, ACMD8, ACMD2, ACMD3, ACMD5 can be used. Hereinafter, the operation mode is referred to as extended mode.

The embedded devices 11 to 14 may retain the flag “First CMD55” and the flag “Compatible mode”. In such case, for example, the flag “First CMD55” and the flag “Compatible mode” are retained in the registers of the embedded devices 11 to 14. However, it is not necessary that the embedded devices 11 to 14 possess these flags themselves. That is, it is only necessary that the embedded devices 11 to 14 be configured such that the operation mode is changed according to the flags. The controller 3 may retain the flags.

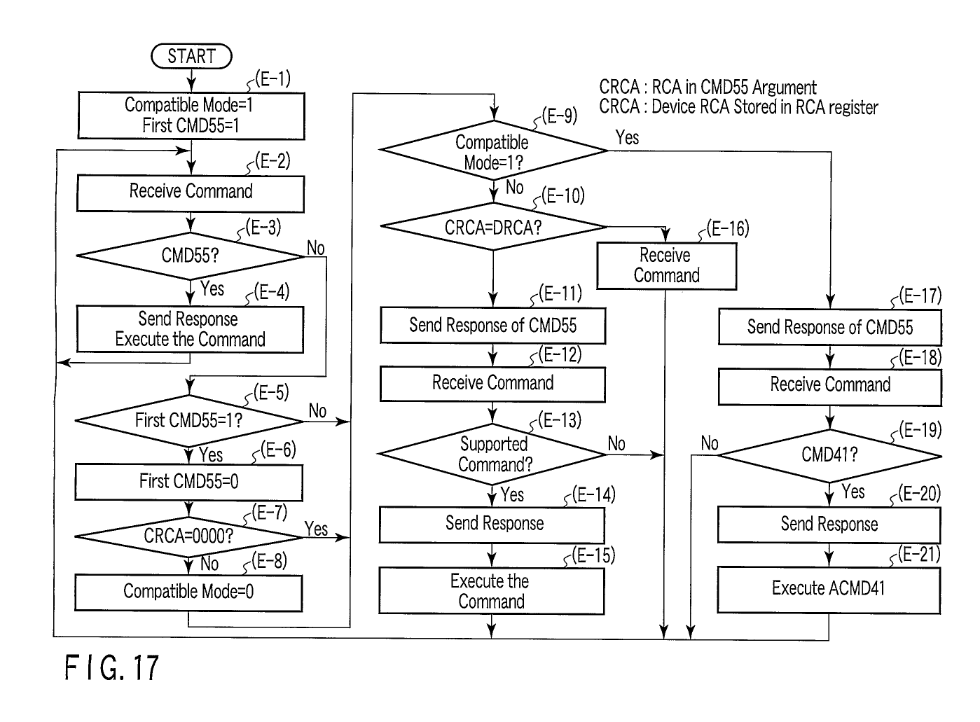

Taking the memory device 11 as an example, the operations of the embedded devices 11 to 14 will be described with reference to FIG. 17. FIG. 17 is a flowchart showing a processing flow performed by the memory device 11. The embedded devices 11 to 14 receive the command from the controller 3, and determine the operation according to contents of the command. Therefore, the operations of the embedded devices 11 to 14 include a loop of the command reception and the processing of the command. The flowchart of FIG. 17 is valid only for the initialization period, and the flowchart is valid when the embedded devices 11 to 14 are in the idle state and initialization of FIG. 13. The following processing described below is performed by the controllers lib to 14b included in the devices 11 to 14. The following functions may be realized by software or hardware such as a wired logic.

The memory device 11 sets both the flag “Compatible mode” and the first CMD55 to “1b” (Step E-1). When the memory device 11 receives the command from the controller 3 (Step E-2), the memory device 11 determines whether or not the command is CMD55 (Step E-3).

When the command is not CMD55 (NO in Step E-3), the memory device 11 sends back the response to the command, and performs the command according to the definition (Step E-4).

When the command is CMD55 (YES in Step E-3), the memory device 11 determines whether or not CMD55 is the initially-received CMD55 (Step E-5). The determination in Step E-5 can be made based on whether or not the flag “First CMD55” is “1b”. That is, CMD55 is the initially-received CMD55 when the flag “First CMD55” is “1b”, and CMD55 is not the initially-received CMD55 when the flag “First CMD55” is “0b”.

When CMD55 is the initially-received CMD55 (YES in Step E-5), the memory device 11 sets the flag “First CMD55” to “0b”. At this point, all the embedded devices 11 to 14 which have received CMD55 set the flag “First CMD55” to “0b”. Then, the memory device 11 checks RCA in CMD55, that is, CRCA (Step E-7).

When CRCA is not “0000h” (NO in Step E-7), that is, when one of the embedded devices 11 to 14 is selected, the memory device 11 sets the flag “Compatible mode” to “0b”. Therefore, the memory device 11 is operated in the extended mode.

On the other hand, when CRCA is “0000h” (YES in Step E-7), the memory device 11 keeps the flag “Compatible mode” at “1b”, that is, the memory device 11 maintains the compatible mode. Even if CMD55 is received henceforth, the processing in Steps E-6 to E-8 is not performed (because of NO in Step E-5). That is, the memory device 11 is always operated in the compatible mode unless the extended mode is set in Step E-8. All the embedded devices 11 to 14 which have received CMD55 set the flag “Compatible mode” to “0b”.

When the flag “First CMD55” is set to “0b” in Step E-5, when CRCA is set to “0000h” in Step E-7, or when the flag “Compatible mode” is set to “0b” in Step E-8, the memory device 11 determines whether or not the memory device 11 is in the extended mode (Step E-9).

When the embedded device 11 is in the extended mode, that is, when the flag “Compatible mode” is set to “0b” (NO in Step E-9), the memory device 11 compares CRCA to an RCA value retained by the register of the memory device 11 (hereinafter referred to as DRCA) (Step E-10).

When CRCA is matched with DRCA, that is, when CRCA is equal to DRCA (YES in Step E-10), the memory device 11 recognizes that the destination of CMD55 is the memory device 11, and the memory device 11 sends back the response to the controller 3 (Step E-11).

When the memory device 11 receives the subsequent command from the controller 3 (Step E-12), the memory device 11 determines whether or not the received command can be executed in the initialization processing (Step E-13). When command can be executed (YES in Step E-13), the memory device 11 sends back the response of the command to the controller 3 (Step E-14), and executes the command (Step E-15). Then, the flow returns to Step E-2.

When the command cannot be executed (NO in Step E-13), the memory device 11 performs nothing (does not send back the response). Then the flow returns to Step E-2. When CRCA is not matched with DRCA (NO in Step E-10), the memory device 11 recognizes that the destination of CMD55 is not the memory device 11. Although the memory device 11 receives the subsequently-issued command (Step E-16), the memory device 11 ignores the command, and does not send back the response. Then, the flow returns to Step E-2.

When the memory device 11 in the compatible mode in Step E-9, that is, when the flag “Compatible mode” is set to “1b” (YES in Step E-9), the memory device 11 sends back the response of CMD55 to the controller 3 (Step E-17). Then, the memory device 11 receives the subsequent command (Step E-18). When the command received in Step E-18 is CMD41 (YES in Step E-19), the memory device 11 sends back the response of ACMD41 to the controller 3 (Step E-20), and executes ACMD41 (Step E-21).

When the command received in Step E-18 is not CMD41 (NO in Step E-19), the memory device 11 does not send back the response and not performs the processing. Then, the flow returns to Step E-2. This is because, in the commands including CMD55 (YES in Step E-3), CMD41 is the only recognizable command during the initialization processing in the compatible mode.

Then, the memory device 11 receives the next command, and repeats the similar processing until the initialization is completed. The flowchart of FIG. 17 holds true for the memory device 12. The flowchart of FIG. 17 holds true for the embedded devices 13 and 14 except that the command determined in Step S19 is CMD5 (=ACMD5).

When the memory device 11 receives CMD8 with QBR=“1b” or ACMD8 with QBR=“1b” and CRCA=“0001h”, the memory device 11 performs the quick boot in Step E-15. That is, the sequence shown in FIG. 17 is interrupted, and the boot code is read from the boot code area.

When the boot code read is completed, the flow returns to Step E-2.

In the SD interface, the first embodiment can be applied in the above-described manner.

### Sixth Embodiment

A sixth embodiment of the invention will be described below. The sixth embodiment relates to the further specific operation when the second embodiment is applied to the SD interface.

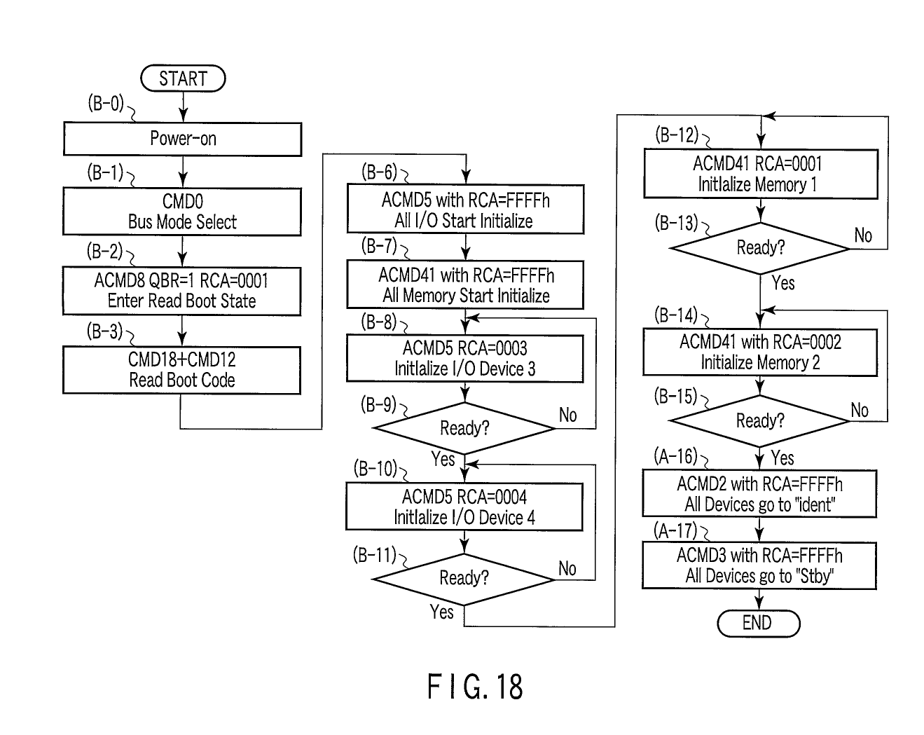

The initialization operation of the embedded devices 11 to 14, performed by the controller 3 of the sixth embodiment, will be described with reference to FIG. 18. FIG. 18 is a flowchart showing a processing flow performed by the controller 3.

As shown in FIG. 18, the controller 3 turns on the embedded devices 11 to 14 (Step B-0). Then, the controller 3 performs the processing in Steps B-1 to B-3 and B-6 to B-17. The processing in Steps B-1 to B-3 and B-6 to B-17 correspond to the processing in Steps S2 to S4, S32, S33, S12, S15, S22, S23, and S25 to S28 of FIG. 9 described in the second embodiment.

The controller 3 performs the processing in Steps B-1 to B-3. The processing in Steps B-1 to B-3 is similar to those in Steps A-1 to A-3 of the fifth embodiment.

The controller 3 issues ACMD5 with RCA=“FFFFh” (Step B-6). This enables the embedded devices 13 and 14 to start the initialization. The controller 3 issues ACMD41 with RCA=“FFFFh” (Step B-7). This enables the memory devices 11 and 12 to start the initialization.

Then, the controller 3 confirms whether or not the initialization of the embedded devices 11 to 14 is completed. That is, the controller 3 performs the processing in Steps B-8 to B15. Because the processing in Steps B-8 to B15 is similar to those in Steps A-6, A-7, A-9, A-10, A-12, A-13, A-15, and A-16 of the fifth embodiment, the description thereof is omitted.

Finally the controller 3 issues ACMD2 with RCA=“FFFFh” and ACMD3 with RCA=“FFFFh” (Step B-16 and B-17). Then, the initialization is completed.

In the SD interface, the second embodiment can be applied in the above-described manner. The processing in Steps S5 and S31 of FIG. 9 can be omitted using ACMD41. Accordingly, the issue of the reset command is omitted in Step S5 to eliminate another voltage check, and the initialization of the memory device can be started by ACMD41.

### Seventh Embodiment

A seventh embodiment of the invention will be described below. The seventh embodiment relates to the further specific operation when the third embodiment is applied to the SD interface.

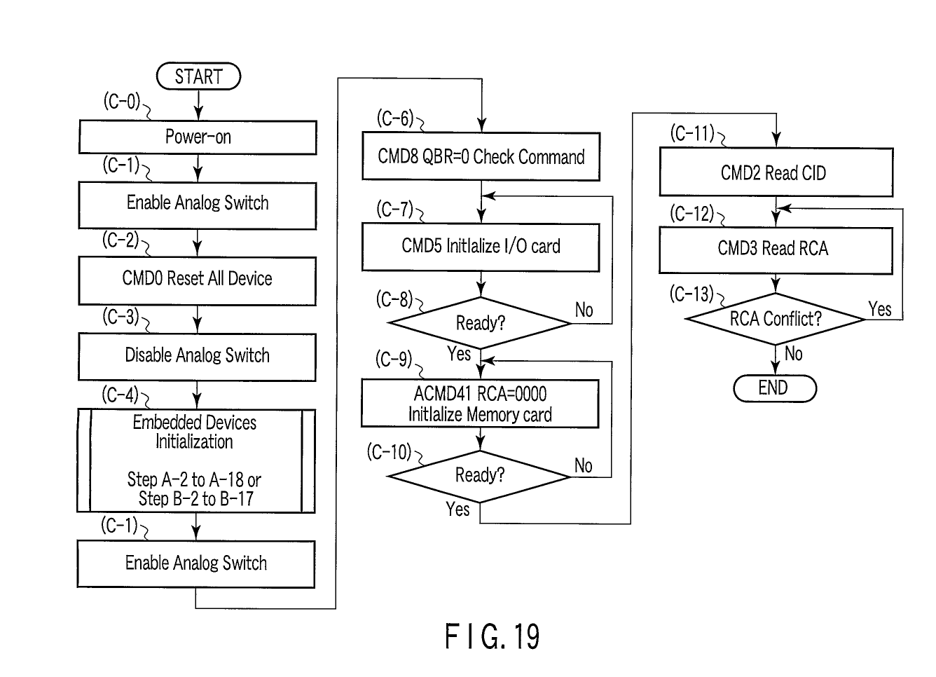

The initialization operation of the embedded devices 11 to 14, performed by the controller 3 of the seventh embodiment, will be described with reference to FIG. 19. FIG. 19 is a flowchart showing a processing flow performed by the controller 3.

As shown in FIG. 19, the controller 3 turns on the embedded devices 11 to 14 (Step C-0). Then, the controller 3 performs the processing in Steps C-1 to C-13. The processing in Steps C-1 to C-3 corresponds to the processing in Step S41, S2, and S42 of FIG. 11 described in the third embodiment. The processing in Step C-4 corresponds to the processing from the boot read to ID and address requests in FIG. 11, that is, the processing in Step C-4 corresponds to the processing in Steps A-2 to A-18 or B-2 to B-17. The processing in Steps C-5 and C-6 corresponds to the processing in Steps S43 and S44 of FIG. 11. The processing in Steps C-7 to C-10 corresponds to the processing in Steps S45 and S46 of FIG. 11. The processing in Steps C-11 to C-13 corresponds to the processing in Steps S51 to S53 of FIG. 11.

The controller 3 issues CMD 8 with QBR=“0b” (Step C-6). This enables the voltage check of the card device 5 to be performed. The controller 3 then issues CMD5 (Step C-7) to initialize the card device 5. Then, the controller 3 sequentially issues ACMD9, CMD2, and CMD3 to complete the initialization.

### Eighth Embodiment

An eighth embodiment of the invention will be described below. The eighth embodiment relates to the further specific operation when the fourth embodiment is applied to the SD interface.

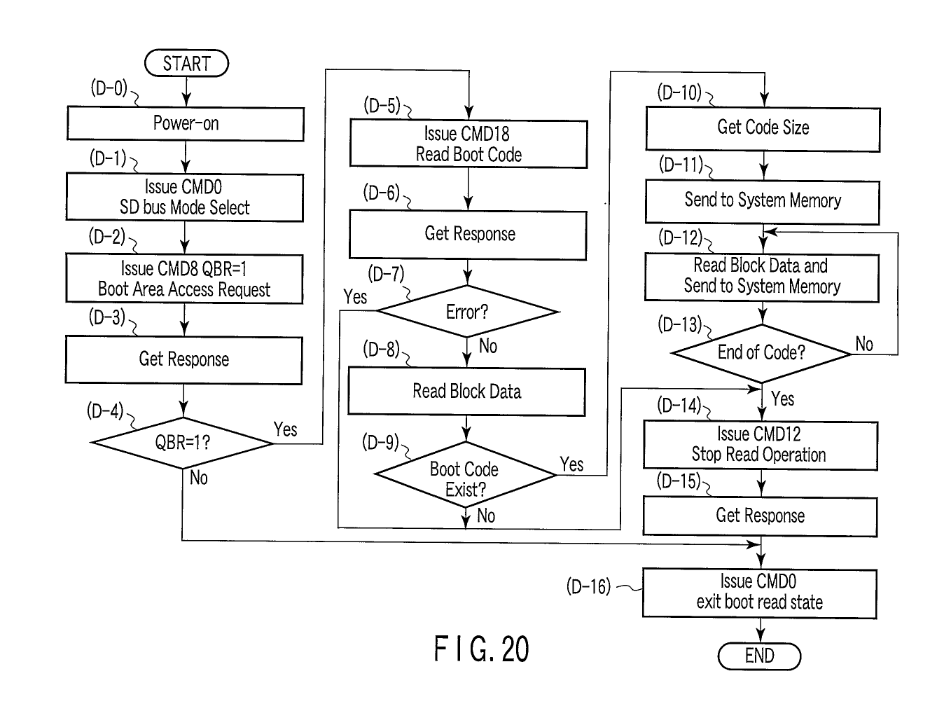

The boot code read operation performed by the controller 3 of the eighth embodiment will be described with reference to FIG. 20. FIG. 20 is a flowchart showing a processing flow performed by the controller 3.

As shown in FIG. 20, the controller 3 turns on the embedded devices 11 to 14 (Step D-0). Then, the controller 3 performs the processing in Steps D-1 to D-16. The processing in Steps D-1 to D-16 correspond to the processing in Steps S2, S61 to S66, S71 to S76, S81, S82, and S5 of FIG. 12 of the fourth embodiment. When the response is not obtained in Step D-3, the flow may go to Step D-16. In Step D-2, ACMD8 can be used instead of CMD8.

### Ninth Embodiment

A ninth embodiment of the invention will be described below. The ninth embodiment relates to the details of the quick boot in the first to eighth embodiments, and the Operating System (OS) is read in performing the quick boot in the ninth embodiment. Only the points different from those of the first to eighth embodiments will be described below.

<Configuration of Host Apparatus 1>

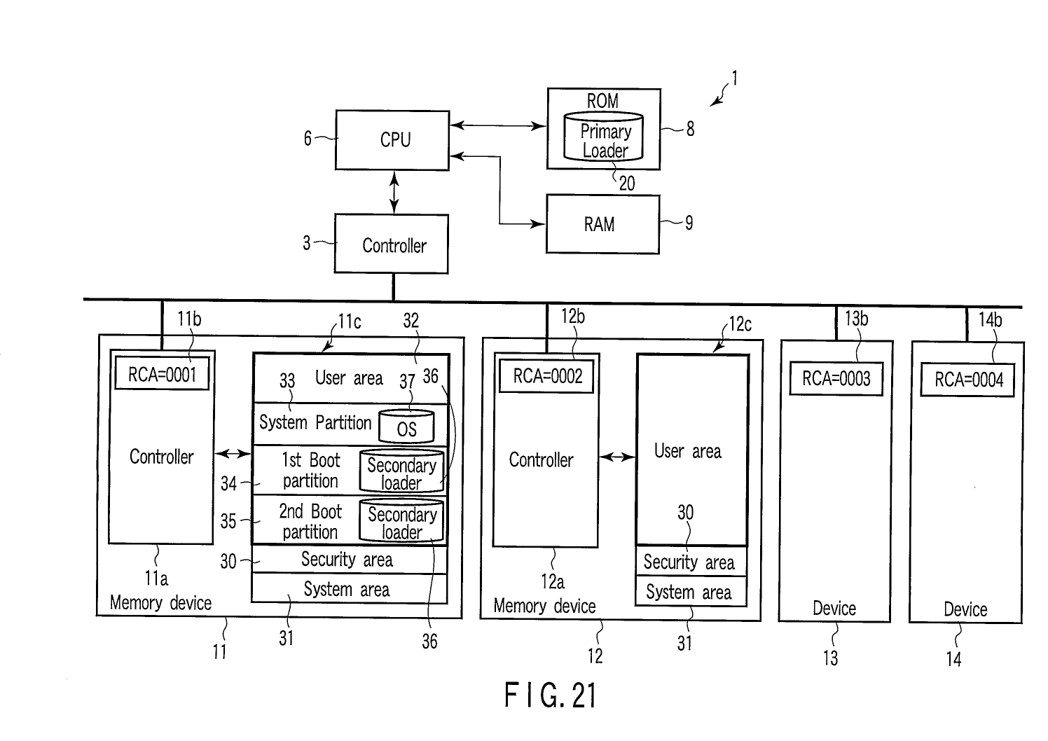

FIG. 21 is a block diagram showing a main part of the host apparatus 1 of the ninth embodiment. In a configuration of the ninth embodiment, a ROM 8 and a RAM 9 are added to the configuration of FIG. 1 of the first embodiment. The ninth embodiment also differs from the first embodiment in the configuration of the flash memory 11c in the memory device 11. Other configurations and operations are identical to those of the first embodiment although partially omitted in FIG. 21.

The ROM 8 and RAM 9 may be included in the system memory 7 of FIG. 1. The ROM 8 is formed by a semiconductor memory which retains a primary loader 20. The primary loader 20 is a program executed by the CPU 6, and is executed in performing the initialization of the embedded devices 11 to 14 and the quick boot in the first to eighth embodiments.

The RAM 9 is formed by a semiconductor memory such as DRAM, and is used as a work area of the CPU 6. For example, the CPU 6 reads the primary loader 20 onto the RAM 9 to produce a table necessary in the RAM 9. OS (operating system) is also read on to the RAM 9 and executed by the CPU 6.

The memory device 11 includes the NAND type flash memory 11c. The NAND type flash memory 11c includes a security area 30, a system area 31, a user area 32, a system partition 33, a first boot partition 34, and a second boot partition 35. The security area 30, the system area 31, and the user area 32 correspond to the system area 11c4, the security area 11c3, and the user area 11c1 in FIG. 2 of the first embodiment.

The system partition 33 is managed any file system (for example, FAT file system), and the OS program and data are stored in the system partition 33. OS is started up by executing the program using the data. The first and second boot partitions 34 and 35 are not managed by the file system, but the first and second boot partitions 34 and 35 retain secondary loaders 36 respectively. The secondary loader 36 is a program executed by the CPU 6, and is executed in reading OS from the system partition 33. Each of the system partition 33, the first boot partition 34, and the second boot partition 35 is one which is physically partitioned from the user area 32. Accordingly, the CPU 6 recognizes the partitions 33 to 35 as the area which is physically different from the user area 32. The first and second boot partitions 34 and 35 correspond to the boot code area 11c2 of FIG. 2 in the first embodiment.

The system partition 33 and the first and second boot partitions 34 and 35 are configured such that the write is prohibited. This is because the OS program and data and the secondary loader are prevented from being carelessly altered to disable the start-up of the system. However, in order to update OS and the secondary loader, it is necessary to rewrite OS program and data and the secondary loader. Therefore, the controller 3 has a command or hardware device for releasing the write prohibition of the system partition 33 and the first and second boot partitions 34 and 35. The controller 3 can access the system partition 33 and the first and second boot partitions 34 and 35 to rewrite the OS program and data and the secondary loader by issuing the command or using the hardware device.

In the NAND type flash memory 11c, the user area 32, the system partition 33, and the first and second boot partitions 34 and 35 are areas which the CPU 6 can arbitrarily access. On the other hand, the security area 30 and the system area 31 are not the areas which the CPU 6 can arbitrarily access. The CPU 6 can access the security area 30 only when a predetermined condition is satisfied, and only the controller 11a of the memory device 11 can access the system area 31.

The memory device 12 has a configuration in which the system partition 33 and the first and second boot partitions 34 and 35 are removed from the memory device 11. The devices 13 and 14 have the same configurations as the first embodiment.

<Schematic Flow of Initialization Operation of Embedded Devices 11 to 14>

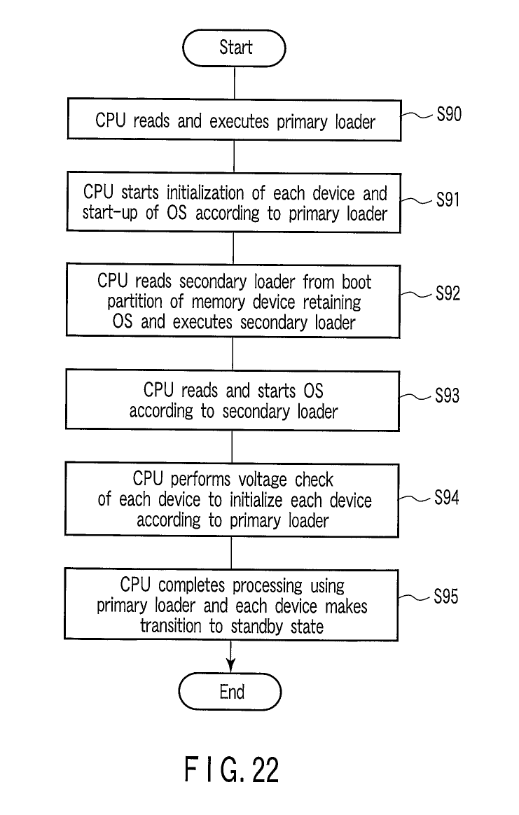

A schematic flow of the initialization operation of the embedded devices 11 to 14, performed by the CPU 6 and the controller 3, will be described with reference to FIG. 22. FIG. 22 is a timing chart showing operations of the CPU 6 and the controller 3.

As shown in FIG. 22, the CPU 6 executes the primary loader 20 in the ROM 8 (Step S90). This enables the CPU 6 to start the initialization of the devices 11 to 14 and the OS start-up operation according to the primary loader 20 (Step S91).

In performing the initialization and the OS start-up, the CPU 6 provides a command for reading the secondary loader 36 to the controller 3. In response to the command from the CPU 6, the controller 3 reads the secondary loader 36 from one of the first and second boot partitions 33 and 35 of the memory device 11, and stores the secondary loader 36 in the RAM 9. The CPU 6 executes the secondary loader 36 stored in the RAM 9 (Step S92).

Then, the CPU 6 provides a command for reading OS program and data to the controller 3 according to the secondary loader 36. In response to the command from the CPU 6, the controller 3 accesses the system partition 33 of the memory device 11 to read OS program and data 37, and the controller 3 stores the OS program and data 37 in the RAM 9. Then, the CPU 6 executes the OS program 37 stored in the RAM 9 to start the OS (Step S93). When the OS is started, the processing based on the secondary loader 36 is completed.

Then, the CPU 6 provides a command for initializing the devices 11 to 14 to the controller 3 according to the secondary loader 36. In response to the command from the CPU 6, the controller 3 performs the processing for the initialization such as the voltage checks of the devices 11 to 14 (Step S94). Each of the devices 11 to 14 is transferred to the standby state by the initialization, and the CPU 6 completes the processing based on the primary loader 20 (Step S95).

<State Transitions of Embedded Devices 11 to 14>

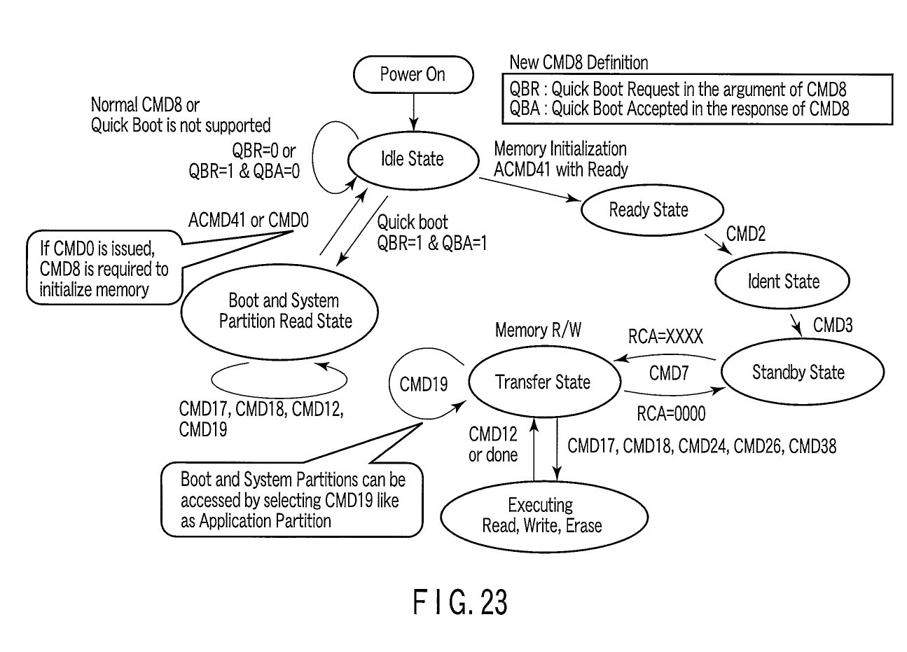

The state transition of the memory device 11 will be described with reference to FIG. 23. FIG. 23 shows the state transition of the memory device 11. Because the state transition of FIG. 23 is basically similar to that of FIG. 15, only the points different from those of FIG. 15 will be described below.

When the controller 3 issues the quick boot command to the memory device 11, the memory device 11 makes the transition from the idle state to a boot and system partition read state. The boot and system partition read state corresponds to the boot read state to which the transition is made by the quick boot command (ACMD8 or CMD8 in which QBR is set to “1b”) in FIG. 15. In the boot and system partition read state, the controller 3 can access the first and second boot partitions 34 and 35 and the system partition 33.

When the controller 3 issues ACMD8 or CMD8 in which QBR is set to “1b”, the memory device 11 sends back the response in which QBA (Quick Boot Accepted) is set to “1b”, which allows the memory device 11 to make the transition from the idle state to the boot and system partition read stat. The response to ACMD8 or CMD8 has a configuration in which QBR is replaced by QBA in CMD8 of FIG. 14. QBA is information indicating whether or not the quick boot command is accepted. The quick boot command is accepted in the case of QBA=“1b”, and the quick boot command is not accepted in the case of QBA=“0b”.

In the boot and system partition read state, the secondary loader 36 is read using CMD 12 and CMD17 to CMD19, and the secondary loader 36 reads the OS program and data 37 using CMD12 and CMD17 to CMD19. CMD 19 is used to select the first and second boot partitions 33 and 34 and the system partition 33. Obviously CMD12 and CMD17 to CMD19 may be an extended command to which CMD55 is added.

When the controller 3 issues ACMD41 or CMD0 to the memory device 11, the memory device 11 makes the transition from the boot and system partition read state to the idle state. At this point, another voltage check (ACMD8 or CMD8) is required in the case where the memory device 11 makes the transition to the idle state by CMD0.

When the controller 3 issues ACMD41 to the memory device 11, the memory device 11 makes the transition from the idle state to the ready state. The unique ID number of the device can be transmitted in the ready state. That is, the memory device 11 is in the state in which ACMD2 or CMD2 can be accepted.

When the controller 3 issues ACMD2 or CMD2 to the memory device 11, the memory device 11 makes the transition from the ready state to an identification state (ident state). The address of the memory device 11 can be transmitted in the ident state. That is, the memory device 11 is in the state in which ACMD3 or CMD3 can be accepted.

When the controller 3 issues ACMD3 or CMD3 to the memory device 11, the memory device 11 makes the transition from the ident state to the standby state. The transition of the memory device 11 from the ident state to the standby state completes the initialization of the memory device 11. The standby state is similar to that of FIG. 5.

When the controller 3 issues CMD7 to the memory device 11, the memory device 11 makes the transition from the standby state to the transfer state. At this point, it is obviously necessary that the argument of the issued CMD7 include RCA retained by the memory device 11. In the transfer state, the controller 3 can access the system partition 33 and the first and second boot partitions 34 and 35 using CMD19. However, even if the controller 3 accesses the system partition 33 and the first and second boot partitions 34 and 35 in the transfer state, the memory device 11 does not make the transition to the boot and system partition read state. The boot and system partition read state is one in which the memory device 11 can make the transition by the quick boot command.

<Initialization Operation of Memory Device 11>

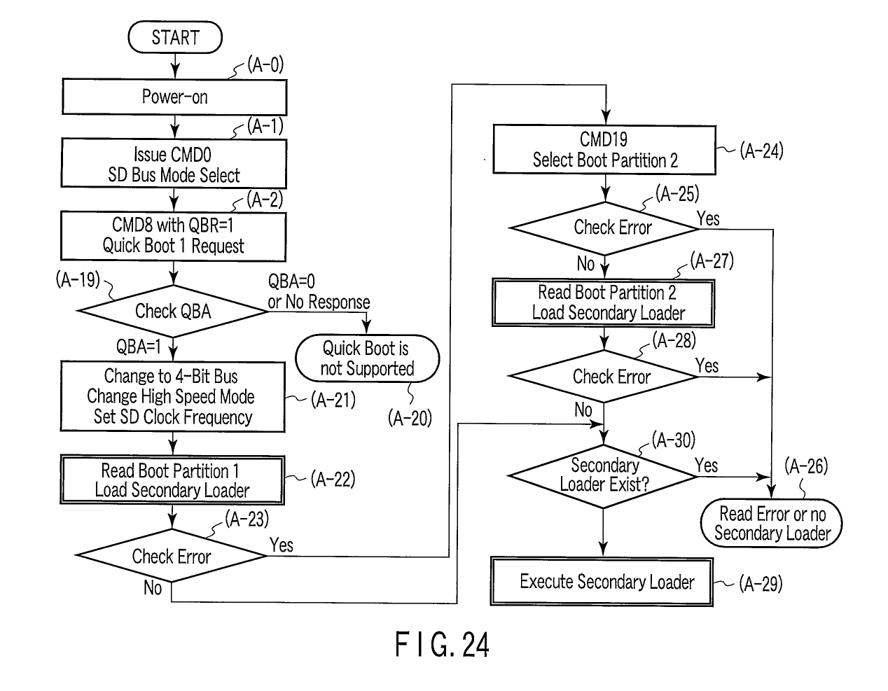

Focusing on the quick boot, the initialization operation of the embedded devices 11 to 14, performed by the controller 3, will be described with reference to FIG. 24. FIG. 24 is a flowchart showing a processing flow performed by the controller 3, and FIG. 24 shows the processing performed according to the primary loader 20.

The controller 3 reads the primary loader 20 from the ROM 8 and executes the primary loader 20 in the ROM 8. The controller 3 performs the processing in Steps A-0 to A-2 of FIG. 16 according to the primary loader 20. Usually the devices 11 to 14 are in the SD mode by default, so that CMD0 in Step A-1 can be omitted. In Step A-2, the controller 3 issues ACMD8 when the plural devices support CMD8, and issues ACMD8 or CMD8 when only one device supports CMD8. At this point, the controller 3 sets the argument QBR of ACMD 8 or CMD 8 to “1b” when the quick boot is required, and the controller 3 sets QBR to “0b” when the quick boot is not required.

When receiving ACMD8 or CMD8, the devices 11 to 14 send back the response including QBA. When the quick boot is not required, or when the device does not support the quick boot, QBA is set to “0b” in the response. The device which does not support CMD8 does not send back the response. Accordingly, when the controller 3 receives the response in which the QBA is set to “0b” to the quick boot command issued in Step A-2, or when the controller 3 does not receive the response (QBA=0 or NO Response in Step A-19), the controller 3 determines that the devices 11 to 14 do not support the quick boot (Step A-20). The flow then goes to Step A-5 of FIG. 16 or Step B-5 of FIG. 18, and the usual initialization processing is performed.

On the other hand, when the controller 3 receives the response in which QBA is set to “1b” (QBA=1 in Step A-19), the controller 3 starts the quick boot processing. The device which supports the quick boot responds to ACMD8 or CMD8 in which QBR is set to “1b”, and the device is changed to the four-bit bus mode within eight clocks since the transmission of the response to ACMD8 or CMD8 is ended (Step A-21).

Two bus modes, that is, the one-bit bus mode and the four-bit bus mode can be used in the SD interface. The one-bit bus mode has a bus width of one bit, and can be operated at the maximum frequency of 400 kHz (hereinafter referred to as normal speed mode). The four-bit bus mode has a bus width of four bits, and is operated at the maximum frequency of 50 MHz (hereinafter referred to as high speed mode). Both the normal speed mode and the high speed mode can be operated in the four-bit bus mode, while only the normal speed mode can be operated in the one-bit bus mode.

Similarly to the devices 11 to 14, the controller 3 is changed to the four-bit bus mode (Step A-21). At this point, a bus operating frequency may be changed from the normal speed mode to the high speed mode, or a determination whether or not the bus operating frequency is changed to the high speed mode may be made by a regulation between the controller 3 and the devices 11 to 14.

The controller 3 issues ACMD18 or CMD18, and accesses the first boot partition 34 to read the secondary loader 36 (Step A-22). CMD18 is the data read command. The first and second boot partitions 34 and 35 are enabled to read the data within 100 ms since CMD18 is issued. The controller 3 refers to an error flag to determine whether or not the data is normally read from the first boot partition 34. The error flag is used to memorize the occurrence of the error when the controller 3 performs various checks (for example, voltage check) to the devices 11 to 14.

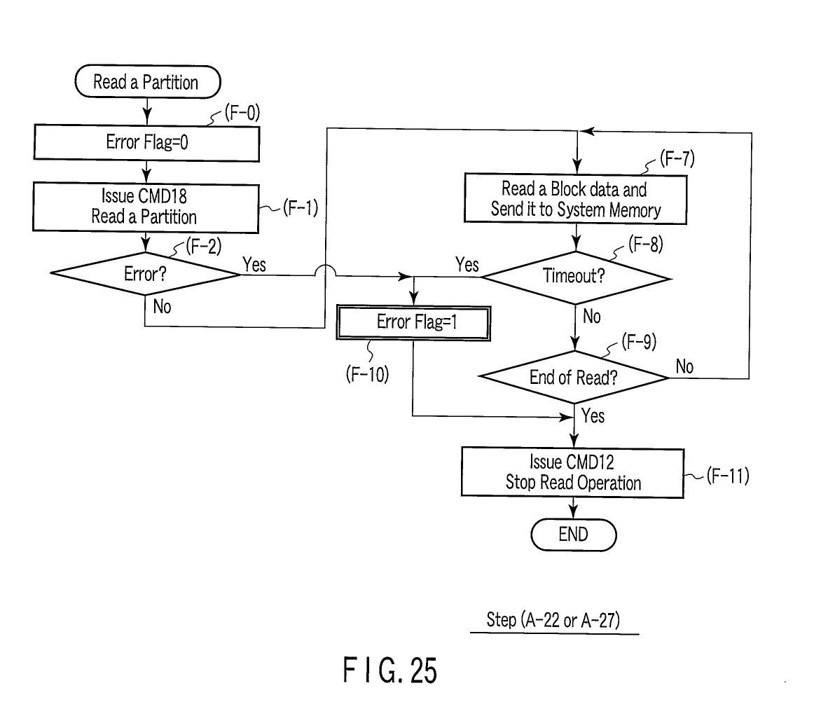

The detailed processing in Step A-22 will be described with reference to FIG. 25. FIG. 25 is a flowchart showing the processing in Step A-22.

In the controller 3, the error flag is set to “0b” (Step F-0). The controller 3 issues CMD18 or ACMD18 (CRCA is RCA of the device which retains the secondary loader 36, RCA=♭0001h” in the ninth embodiment) (Step F-1). CMD18 is the multiple block read command. That is, CMD18 is used to read the plural blocks.

When confirming that the error does not exist in the response to CMD18 from the device 11 (Step F-2, NO), the controller 3 accesses the first boot partition 34 to read the data in a block unit, and transmits the data to RAM 9 (Step F-7). When a read error is occurred in the processing of Step F-7, the device 11 is maintained in the state in which the data is not supplied. The controller 3 detects the read error by setting read time-out. That is, when the data is not supplied for a given period (YES in Step F-8), the controller 3 sets the error flag to “1b” (Step F-10). When the response to CMD18 has the error in Step F-2 (YES in Step F-2), the controller 3 also sets the error flag to “1b”.

When the time-out is not occurred in the data transfer (NO in Step F-8) and when the data is read to the end (YES in Step F-9), the controller 3 issues CMD12 (Step F-11). The controller 3 ends the read operation by issuing CMD12. When the error flag is set to “1b” in Step F-10, the controller 3 also issues CMD12 (Step F-11) to interrupt the data read.

For example, the processing in Step F-9 can be performed using header information. The head address of the first block to which the access is made in Step F-7 includes header information for controlling the read, so that the controller 3 can refer to the header information to understand the size of the secondary loader 36. More specifically, the number of blocks to be read is recorded in the header information. Alternatively, the number of blocks may previously be set in the controller 3. The number of blocks also means the number of loops of Steps F-7 and F-8. When the controller 3 reads the data by the number of blocks obtained from the header information or the preset number of blocks, the controller 3 ends the read.

The first and second boot partitions 34 and 35 are the areas which are not managed by the file system, and the secondary loader 36 is written in the NAND type flash memory 11c in the address order. Therefore, the secondary loader 36 can be read by the one-time multiple block read command (CMD18). CMD18 is used to sequentially read the blocks while the address is increased.

Referring to FIG. 24, after the data (secondary loader 36) is read in Step A-22, the controller 3 checks the error flag. When the error flag is set to “0b” (NO in Step A-23), the controller 3 determines whether or not the valid secondary loader 36 exists in the read data. The determination can be made by previously fixing a pattern indicating that the boot code does not exist, for example, all the specific sites are set to 0 or 1 like the processing in Step S72. When the secondary loader 36 exists (YES in Step A-30), the controller 3 executes the read secondary loader 36 (Step A-29). The processing in Step A-29 is described later.

When the error flag is set to “1b”, that is, when the data is unsuccessfully read (YES in Step A-23), the controller 3 issues CMD19 or ACMD19 (CRCA is RCA of the device which retains the secondary loader 36, RCA=“0001h” in the ninth embodiment) (Step A-24). CMD19 is used to select the partition, and therefore the second boot partition 35 is selected.

When the error does not exist in executing CMD19 (NO in Step A-25), the controller 3 tries to read the secondary loader 36 from the second boot partition 35 (Step A-27). The processing in Step A-27 is described above in FIG. 24.

When the error is occurred in executing CMD19 (YES in Step A-25), the controller 3 determines that the second boot partition 35 does not exist (Step A-26), and the flow goes to Step A-5 of FIG. 16 or Step B-5 of FIG. 18. Then, the usual initialization processing is performed.

As a result of the processing in Step A-27, when the data is successfully read from the second boot partition 35 (NO in Step A-28), the flow goes to Step A-30. When the data is unsuccessfully read (YES in Step A-28), the flow goes to Step A-5 of FIG. 16 or Step B-5 of FIG. 18, and the usual initialization processing is performed.

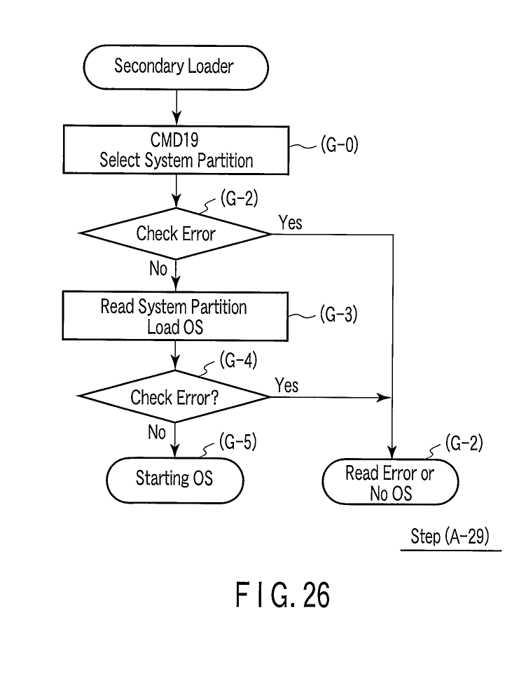

The detailed processing in Step A-29 will be described with reference to FIG. 26. FIG. 26 is a flowchart showing a processing flow performed by the controller 3 based on the secondary loader 36.

As shown in FIG. 26, the controller 3 which starts the execution of the secondary loader 36 issues CMD19 (or ACMD19) to select the system partition 33 (Step G-0). As described above, the system partition 33 is the area in which the program and data of the OS 37 is installed.

When the system partition 33 is unsuccessfully selected (YES in Step G-1), the controller 3 determines that the OS 37 does not exist (Step G-2), and the flow goes to Step A-5 of FIG. 16 or Step B-5 of FIG. 18. Then, the usual initialization processing is performed.

When the system partition 33 is successfully selected (NO in Step G-1), the controller 3 reads the program and data of OS 37 from the system partition 33 (Step G-3). Because the system partition 33 is the area which is managed by the file system, the OS 37 including the plural files is loaded by the plural read commands (CMD18 or ACMD18) according to the management of the file system. The loaded program and data of the OS 37 is stored in the RAM 9.

When the load of the program and data of the OS 37 is completed without occurring of the error in Step G-3 (NO in Step G-4), the CPU 6 starts the OS 37 by executing the program and data read in Step G-3 (Step G-5). When the OS 37 is started, the CPU 6 commands the controller 3 to issue the initialization command (ACMD41) according to the OS 37, and the memory device 11 is initialized. This enables the memory device 11 to access all the partitions.

Then, the devices 12 to 14 are initialized by the method shown in FIG. 16 or 18.

Thus, in the configuration of the ninth embodiment, the OS 37 can be read using the quick boot prior to the initialization of other devices, so that the start of OS can be performed at high speed. In the SD interface, it takes a relatively long time to initialize the devices 11 to 14. Accordingly, when OS is started after all the devices 11 to 14 are initialized, it takes a long time to start up the system. However, in the ninth embodiment, it is not necessary to start OS after all the devices 11 to 14 are initialized, so that OS can be started immediately after the host apparatus 1 is turned on.

In the configuration of the ninth embodiment, the bus can be changed to the four-bit bus mode in response to the quick boot command (ACMD8 or CMD8), and the bus can also be changed to the high speed mode. The command input (CMD6 and ACMD6 in the conventional technique) used to change the bus mode can also be eliminated. Accordingly, the speed enhancement can be achieved in the read operations of the secondary loader 36 and OS 37. This also contributes to the high-speed start of OS.

The memory device 11 includes the plural (two in the ninth embodiment) boot partitions 34 and 35. Therefore, even if the secondary loader 36 is unsuccessfully read from the first boot partition 34 for some reasons, the secondary loader 36 is read from the second boot partition 35, so that system reliability can be improved. At least three boot partitions may be provided.

In the ninth embodiment, using CMD19, the partition in the device can be selected prior to the initialization. At this point, only the selection of the boot partitions 34 and 35 and the system partition 33 is permitted. In other words, CMD19 is the command which can select only the boot partitions 34 and 35 and the system partition 33. Accordingly, the access to the user area 32 prior to the initialization is prevented, so that the user data can be protected.

In the first to ninth embodiments, RCA retained in the registers 11b to 14b by the memory devices 11 to 14 may previously be written during manufacturing process, or RCA may be rewritten or set by connection pins accessible to the outside. For example, the host apparatus 1 can be applied to a portable telephone and a personal computer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A memory device being capable of having a first state and a second state, comprising:
a semiconductor memory which has a first storage area and a second storage area, data of the semiconductor memory being writable in, readable from, and erasable from the first storage area of the semiconductor memory in the first state or being at least readable from the second storage area in the second state; and
a controller which controls the semiconductor memory,
the controller being configured to recognize a plurality of first commands, a second command, and a third command, the first commands transferring the memory device to the first state after the memory device is turned on, each first command including one or more commands, the second command transferring the memory device from the first state to the second state, the third command transferring the memory device to the second state without passing through the first state after the memory device is turned on, the third command including one or more commands,
the controller outputting a response indicating that the memory device makes a transition to the second state, when the memory device makes the transition to the second state by receiving the second command in the first state, and
the controller outputting a response indicating that the memory device makes a transition to the second state, when the memory device makes the transition to the second state by receiving the third command after the memory device is turned on.

2. The device according to claim 1, wherein the controller includes a register which retains a destination address value allocated to the memory device,
the memory device makes a transition to the second state and the controller outputs a response indicating that the memory device makes the transition to the second state, when the third command does not include a destination address section indicating a destination address,
the memory device makes a transition to the second state and the controller outputs a response indicating that the memory device makes the transition to the second state, when the third command includes a destination address section indicating a destination address which has a value equal to a value retained by the register, and
the memory device does not execute the third command and the controller does not output a response, when the third command includes a destination address section indicating a destination address which has a value different from a value retained by the register.

3. The device according to claim 1, wherein one of the first commands includes an instruction section which specifies whether or not the memory device is transferred to the second state,
the third command is the one of the first commands including the instruction section or an extended command in which a destination address is added to the one of the first commands, and
a response to the third command includes a denotation section indicating whether or not a transition to the second state is made.

4. The device according to claim 1, wherein the controller is capable of communicating with a host apparatus through a bus,
the bus is capable of having a first mode and a second mode,
in the first mode, the controller communicates using a first bus width or a first frequency,
in the second mode, the controller communicates using a second bus width larger than the first bus width or a second frequency higher than the first frequency, and
the controller communicates in the second mode when the controller receives the third command after the controller is turned on.

5. A memory device comprising:
a semiconductor memory which includes a arbitrarily accessible first partition, and is capable of being configured with a second partition and a third partition, the second partition and the third partition being accessible only under a predetermined condition; and
a controller which controls the semiconductor memory,
in case of that the semiconductor memory is configured with the second partition and the third partition, the memory device being capable of having a first state, a second state, and a third state, data of the semiconductor memory being writable in, readable from, and erasable from the first partition in the first state, being readable from the second partition in the second state, or being readable from the third partition in the third state,
the controller being configured to recognize a plurality of first commands, a second command, and a third command, the first commands transferring the memory device to the first state after the memory device is turned on, each first command including one or more commands, the second command transferring the memory device from the first state to the second state or from the second state to the third state, the third command transferring the memory device to the second state without passing through the first state after the memory device is turned on, the third command including one or more commands,
the controller outputting a response indicating that the memory device makes a transition to the second state, when the memory device makes the transition to the second state by receiving the second command in the first state, the second command including an instruction for transferring the memory device to the second state,
the controller supplying a response indicating that the memory device makes a transition to the second state, when the memory device makes the transition to the second state by receiving the third command after the memory device is turned on, and
the controller outputting a response indicating that the memory device makes a transition to the third state, when the memory device makes the transition to the third state by receiving the second command in the second state, the second command including an instruction for transferring the memory device to the third state.

6. The device according to claim 5, wherein the controller includes a register which retains a destination address value allocated to the memory device,
in case of that the semiconductor memory is not configured with the second partition and third partition,
the memory device does not make a transition to the second state and the controller outputs a response indicating that the memory device does not make the transition to the second state, when the third command does not include a destination address section indicating a destination address,
the memory device does not make a transition to the second state and the controller outputs a response indicating that the memory device does not make the transition to the second state, when the third command includes a destination address section indicating a destination address which has a value equal to a value retained by the register, and
the memory device does not execute the third command and the controller does not output a response, when the third command includes a destination address section indicating a destination address which has a value different from a value retained by the register.

7. The device according to claim 5, wherein one of the first commands includes an instruction section which specifies whether or not the memory device is transferred to the second state,
the third command is the one of the first commands including the instruction section or an extended command in which a destination address is added to the one of the first commands, and
a response to the third command includes a denotation section indicating whether or not a transition to the second state is made.

8. The device according to claim 5, wherein, in case of that the semiconductor memory is configured with the second partition and third partition,
the third partition retains a program and data for an installed operating system, and
the second partition retains a first program to start the operating system installed in the third partition.

9. The device according to claim 5, wherein the third partition is managed using a file system, and
the second partition is managed with no file system, and the first program is read in order of an address.

10. The device according to claim 8, wherein the semiconductor memory is further configured with a fourth partition,
in the memory device, the second partition and the fourth partition is readable in the second state,
the fourth partition retains a program similar to the first program, and
in the second state, a read area is changed from the second partition to the fourth partition by the second command, and read is selectively performed for the second partition or the fourth partition.

11. The device according to claim 5, wherein the controller is capable of communicating with a host apparatus through a bus,
the bus is capable of having a first mode and a second mode,
in the first mode, the controller communicates using a first bus width or a first frequency,
in the second mode, the controller communicates using a second bus width larger than the first bus width or a second frequency higher than the first frequency, and
the controller communicates in the second mode when the controller receives the third command after the controller is turned on.

12. The device according to claim 5, wherein data is prohibited from being written in the second partition and the third partition in the second state and the third state, and
the memory device is configured to recognize one or more fourth commands which enable data to be written in the second partition and the third partition.

13. An electronic device comprising a register which retains a destination address used to select the electronic device,
the electronic device being configured to recognize a command with first format and a command with second format, the command with the first format being required to be supplied before initialization of the electronic device is completed after the electronic device is turned on, the command of the first format having no destination addresses and including one or more commands,
the command with the second format being required to be supplied before the initialization of the electronic device is completed after the electronic device is turned on, the command with the second format including a destination address section having a destination address and including one or more commands,
the electronic device outputting a response and executing processing instructed by the command with the first format, when the electronic device receives the command with the first format and the command with the first format is executable by the electronic device,
the electronic device outputting a response and executing processing instructed by the command with the second format, when the electronic device receives the command with the second format having a value equal to a value retained by the register in the destination address section,
the electronic device executing processing instructed by the command with the second format without outputting a response, when the electronic device receives the command with the second format having a value indicating a broadcast in the destination address section, and
the electronic device ignoring the command with the second format with no response, when the electronic device receives the command with the second format having a value other than the broadcast and different from a value retained by the register in the destination address section.

14. The device according to claim 13, wherein the electronic device is configured to recognize the command with the second format for all the commands required to be supplied before initialization of the electronic device is completed after the electronic device is turned on.

15. A host apparatus comprising:
a slot into which a removable card device is inserted;
a first bus which is connected to the slot;
a first host controller which enables communication with the card device through the first bus, and which initializes the card device;
a plurality of the electronic devices recited in claim 13, the each register of the electronic devices retaining values different from one another;
a second bus to which a plurality of the electronic devices are connected; and
a second host controller which selects one of the electronic devices through the second bus to enable communication, and which initializes the electronic device by issuing the command with the second format to transfer the electronic device to a state in which the initialization is completed.

16. A host apparatus comprising:
a bus;
a switch which electrically connects and disconnects the bus and a slot by turn-on and turn-off;
the slot which is connected to the switch and into which a removable card device is inserted;
the one or more electronic devices recited in claim 13 which are connected to the bus; and
a host controller which communicates with the card device and the electronic device through the bus.

17. The apparatus according to claim 16, wherein, in case of that a plurality of the electronic devices are connected to the bus, after the host apparatus is turned on,
the switch is turned off,
the electronic devices have different destination addresses,
the host controller initializes the electronic devices by issuing the command with the second format to transfer the electronic devices to a state in which the initialization is completed,
the switch is turned on after the electronic devices make the transition to the state in which the initialization is completed; and
the host controller executes processing for transferring the card device to the state in which the initialization is completed after the switch is turned on, and the host controller sets a value different from a value of the electronic device to a register indicating a destination address of the card device.

18. The apparatus according to claim 16, wherein the switch is turned on while data transfer is not performed between the host controller and the electronic device, when it is detected that the card device is inserted into the slot, and
the switch is turned off before the card device is removed from the slot, when it is detected that the card device inserted into the slot is to be removed from the slot.

19. A host apparatus comprising:
a system memory;
a bus;
the memory device recited in claim 1 which is connected to the bus; and
a host controller which communicates with the memory device connected through the bus,
the host controller supplying the third command to the memory device,
the host controller determining whether or not the second storage is readable from a response to the third command,
the host controller reading data, if readable, from the second storage area to determine whether or not the data is a valid boot code,
the host controller interrupting the read to discard the already read data when the data is not the valid boot code,
the host controller obtaining a size of the valid boot code described in the data when the data is the valid boot code, and
the host controller executing the valid boot code when a transfer of the valid boot code to the system memory is completed.

20. A host apparatus configured to manage data in the first storage area of the memory device recited in claim 1 using a file system,
to manage data in the second storage area of the memory device using no file system,
to read boot code to a system memory in an address order from the second storage area, and
to execute the boot code from a predetermined site.

21. A host apparatus comprising:
the memory device recited in claim 8;
a host controller which controls an operation of the memory device;
a bus which communicably connects the memory device and the host controller; and
a memory which retains a second program to initialize the memory device,
when the host controller executes the second program,
the host controller issuing the third command to the memory device to read the first program from the second partition after the memory device is turned on,
the host controller reading the program and data of the operating system from the third partition to start the operating system by executing the read first program, and
the host controller completing initialization of the memory device after starting the operating system.

22. The apparatus according to claim 21, wherein the semiconductor memory is further configured with a fourth partition,
the fourth partition is accessible only under the predetermined condition, and retains a program similar to the first program, and
the host controller switches from the second partition to the fourth partition to read a program similar to the first program from the fourth partition using the second command, when the host controller fails to read the first program from the second partition.

23. The apparatus according to claim 22, wherein the bus is capable of having a first mode and a second mode,
in the first mode, the controller communicates using a first bus width or a first frequency,
in the second mode, the controller communicates using a second bus width larger than the first bus width or a second frequency higher than the first frequency, and
the bus is switched from the first mode to the second mode, when the third command is issued after the memory device is turned on, and a response indicating that a transition to the second state can be made is issued.
